(19) United States
(12) Patent Application Publication
(10) Pub. No.: US 2009/0044237 A1
(43) Pub. Date: Feb. 12, 2009

(54) SPORT VIDEO HOSTING SYSTEM AND METHOD

(76) Inventor: Zachary Ryan Keiter, Denver, CO (US)

Correspondence Address: SHERIDAN ROSS PC, 1560 BROADWAY, SUITE 1200, DENVER, CO, 80202, US

(21) Appl. No.: 12/173,007

(22) Filed: Jul. 14, 2008

Related U.S. Application Data
(60) Provisional application No. 60/949,669, filed on Jul. 13, 2007.

(51) Int. Cl. H04N 7/173

(52) U.S. Cl. 725/91

(57) ABSTRACT

A hosting system and method are provided for sharing, analysis, and review of videos, to include sport videos and data concerning athletes and teams. The system can be used for many purposes to include athlete education, recruiting of players, scouting of teams, and coaching analysis. The system is web based where a central server or computer links to a website that is accessible to authorized users over a communications network such as the internet. Data is uploaded to the central server from the various remote users, and the data is selectively edited and shared among the authorized users.

### CROSS REFERENCE TO RELATED APPLICATION

This applications claims priority from the U.S. Provisional Application Ser. No. 60/949,669 filed on Jul. 13, 2007, entitled “Sport Video Hosting System and Method”, the disclosure of which is incorporated herein by reference.

### BACKGROUND OF THE INVENTION

The present invention relates to a hosting system and method especially adapted for providing a comprehensive service for sharing, analysis, and review of sport videos and data concerning athletes and teams at all competitive levels. The system can be used for many purposes to include athlete education, recruiting of players, scouting of teams, coaching analysis of their own teams and others.

For many years, sport game films have been taken so that coaches could evaluate their own team's performance, as well as to scout teams that will be played. Game films are exchanged between teams, and when each team has completed their reviews, the films are returned. Game films are used by college recruiters and professional scouts in order to evaluate the capabilities of prospective players. With the advent of digital film technology interfaced with various software programs, game films may be edited and accessed in a manner that allows the game film reviewers to focus on particular players, different types of plays, among other aspects of a game film.

At the college and professional level, extremely detailed review of game films is undertaken to evaluate individual players, as well as teams. In order to ease the effort required to edit the game films, existing products are knowing which allow metadata to be associated with the game film and the metadata can then be used to categorize or classify different aspects of the game film to focus on not only different players, but particular plays, and other aspects of the game.

Currently, major universities and professional teams have the resources available for editing game film and to otherwise manage the data in the game film so that particular actions can be taken, such as recruiting, or preparing a game plan for an upcoming game. However, each university or professional team may have their-own particular software system to handle special functional requirements, and these individually developed systems can make it very difficult if not impossible to effectively share the data with other teams or other recruiters.

There is a need to provide a web-based sport video hosting system and method that allows coaches, recruiters, and players at all levels to share, and otherwise manage game films as well as other data concerning players and teams. Such a web-based solution not only improves access to game films and player data, but also can provide an opportunity for smaller universities, high schools, and youth league teams to access and share such data in a more cost efficient manner by provision of a subscription service thus eliminating the need for such organizations to actually own their own software systems.

### SUMMARY OF THE INVENTION

In accordance with the present invention, a video hosting system and method are provided. The system is preferably web-based with a central server accessible through the Internet. Game film is shot. Desired metadata is associated with the game film, and the game film is then uploaded to the central server, categorized and stored. Subscribers to the system execute a signup or subscription procedure, and set their preferences for functionality of the system to be applied to the game film to be reviewed. In addition to game film, player and team information may be uploaded to the system server, such as individual player biographies, statistics, etc. Once a subscription or an authorization has been established for the user, the user may view and share data stored at the central server. For example, a particular high school or college may be a subscriber and through authorized access, coaches and players of the organization may review indexed and segmented game films, player biographies, or other data stored at the central server. Other subscribers such as college scouts, professional scouts, or others may view the game film and player information.

There are a number of special features of the present invention that may be incorporated to include the following:

Player metadata may be associated with video content (such as player information, biography, statistics, play results, game overall results, etc.) thereby focusing upon a particular player's contribution and his potential.

Subscribers may determine the manner in which they would like to share their video content uploaded to the system with or without metadata content.

Subscribers have the ability to transfer video from any third party video system and format to the system of the present invention.

Metadata added to the film in the present invention may include the ability to showcase particular players that are highlighted in the videos. The highlighted players are visually distinct from the other players in the game film.

Subscribers have the ability to have mutual delegation, that is, they can chose particular games to share with third parties as well as to select the games that they would like to receive from third parties. Content is not released to either party until each has approved the games and specific data within the games to be delegated.

By use of a web-based solution, information can be shared around the world for other purposes, such as best practices, strategies, and other coaching functions. For example, high school coaches across the country would have the ability to view game films from other high schools that may be running similar offenses or defenses. Further, for example, youth league teams would have access to a wide array of game films for teaching purposes. This use of a web-based solution that allows individuals from around the world to access the various functional features of the system can also provide collaboration capabilities allowing groups of individuals or organizations to collaborate on sharing of film, best practices, game strategies, and other information or data in the system. Further for example, assume that there has been a rule change at the high school or college level, and it is necessary to educate coaches and referees as to how the new rule will be implemented. In this case, the system administrator by request of a subscriber or one of the subscribers (school or university) could search and retrieve game films showing plays that would be affected by the rule change, and through a video-conferencing call, the coaches/referees could view game film at multiple remote locations. The video conferencing host such as the league or conference official, could conduct the video-conferencing meeting to explain the rule change and its affect on the game. In yet another example, assume a coaching clinic was to take place where coaches at a particular competitive level need to review game film showing examples of what is to be taught in the clinic. Again, because of the web-based solution of the present invention, coaches can remotely search, access, and distribute game film to clinic participants in order to view relevant game film.

One important aspect of the present invention is the manner in which data can be accessed and shared. In one preferred embodiment of the present invention, it is contemplated that the system of the present invention is especially adapted for accessing through a DVR/Set Top Box. In another aspect or embodiment of the present invention, organizations such as universities, professional teams, or high school teams, could subscribe to a package integrated within the present invention, and the package provides a real time network solution enabling subscribers to watch game films on demand and on a live request-by-request basis. For example, a package of the present invention could include selected game films such as particular plays, offenses, defenses, or the package could provide the capability for a subscribe to access only certain or all portions of the data in the system. The pricing of the package as well as the content of the package could be tailored to fit particular subscriber needs. Through the subscription, the subscriber could at any time access the system and watch game films or view other data in accordance with the specifications of the subscription package. The subscription could be based upon access through the Internet, or could be accomplished via a private IP network. In the private IP network, one feature of accessing the system through this manner would be to also provide high broadcast quality through a quality of service feature (QoS).

One advantage of providing a standard package is the ability for organizations to leverage their ability to gather the requisite data or information in order to make a decision as to whether to conduct an action, such as creating a particular game plan, recruiting a particular player, adopting a particular offense or defense for one or more games, among other decisions. Thus, in accordance with one aspect of the present invention, it is clear that certain videos can be selected and saved by the system administrator to fit requested criteria set forth by the user, such as a recruiting coordinator or coach. The host server of the present invention stores the recommended content as created by the system administrator. If the subscriber approves of the standard package that has been provided, the user can request additional information on the same player/videos, can save and bookmark the data to again view later, can share with another users such as another coach or staff member, or can also mark the standard package as not being applicable or relevant to their needs. This same process can continue over time as new game films come into the system database as well as new information about particular players, teams, etc.

With respect to a subscription to a system package and accessing the system through a private IP network, one example of a private IP network could include a multi-protocol label-switching (MPLS) network. As understood by those skilled in the art, MPLS is a standard from the IETF for including routing information in the packets of an IP network wherein MPLS is used to ensure that all packets in a particular flow take the same route over a network backbone. An MPLS network can provide the QoS required to support data transfer such as real time voice data, and others. Thus, with the system of the present invention, subscribers can be provided a virtual private VPN service for IP traffic and bandwidth can be guaranteed for real time voice and video data.

By using a DVR/Set Top Box, the video data could be stored for access anytime. Other means may be used to access the system such as personal computers, laptops, satellite TV, a hard-drive integrated within a television, among others.

By use of a web-based solution, it becomes unnecessary for teams to manually exchange videos or to otherwise go to the effort of physically transferring game films since the game films would be available through the Internet.

By providing the meta-tagged data in the films as well as additional player and team information, various search functions can be incorporated such that a subscriber can specifically search for attributes of a team or player, among other search functions.

With respect to another aspect of the present invention, it is contemplated that certain logic may be incorporated within the various functions to help a subscriber of the system to obtain more pertinent or relevant results. For example, a subscriber of the system such as a recruiter may wish to search for potential high school recruits that have certain height, weight, and speed attributes. As explained below in the detailed description, the subscriber may select these parameters in a search function to find potential recruits. However, the subscriber in setting the parameters for the search may forget or may otherwise not be aware that the particular search results may have a significant amount of data that is not ultimately tied to the purpose of the search. More particularly, in this example, if the college recruiter is from an academic institution of high standards, it may be unreasonable for the recruiter to assume that the recruits are viable simply by physical characteristics and not also evaluating their academic potential. Thus, while the subscriber may request a search only based upon physical characteristics, the system of the present invention can highlight or designate certain players that may be best qualified for the search results by provision of a ranking of the players searched along with a text display on the user interface screen explaining that the subscriber should consider searching the data by additional parameters. This example of logic requires that the type of subscriber be identified, that is, a college recruiter from an academic institution having very high standards. Thus, in the signup or subscription process, it is contemplated that this system provides a detailed data gathering process completed by the subscriber relating to the type of subscriber, how the subscriber will use this system, as well as the subscriber's needs. The subscriber would be asked to complete, for example, a comprehensive questionnaire. Thus, the subscriber's search request coupled with an understanding of the type of subscriber may yield the best search results. Further, for example, assume a youth league coach wished to search the system for high school or college video highlights showing particular plays or types of offenses. If the subscriber is identified as a youth coach using the system for teaching purposes, a search request for highlight teaching films would allow the system to pre-select certain plays from videos especially adapted for youth league teaching purposes.

In these two examples, it is, therefore, contemplated that the metadata associated with game films and other data uploaded in the system by subscribers is coupled with an administrator function of providing basic logic that allows the system to identify the best data to be provided to the subscriber based upon the identity of the subscriber and the purpose for which the subscriber is using the system. Certain default functions may also be incorporated such that if a subscriber makes a certain search request but there is no corresponding data or films to be displayed in the search results, the system will automatically generate the next closest matches and these matches again can be based upon the analysis of the type of subscriber and the reason why the subscriber is using the system.

### BRIEF DESCRIPTION OF THE DRAWINGS

FIG. 1 is a table of functional areas and phases;

FIG. 2 is a system architecture overview;

FIG. 3 shows how to create an account;

FIG. 4 shows how to finish registration of an account;

FIG. 5 shows account system functions available;

FIG. 6 illustrates how to manage the games system functions;

FIG. 7 shows sharing and reviewing game video cut-ups and related functions;

FIG. 8 shows a search and query function by a coach subscriber;

FIG. 9 illustrates a search and query function by a recruiter subscriber;

FIG. 10 shows system administration functions;

FIG. 11 is a system data diagram;

FIG. 12 illustrates an account data overview;

FIG. 13 illustrates an account creation process flow;

FIG. 14 shows how to finish registration of an account process flow;

FIG. 15 is a table showing examples of defaulted system functions;

FIG. 16 shows a registered subscriber user process flow;

FIG. 17 illustrates a manage games process flow;

FIG. 18 shows a sharing game video cut-ups process flow;

FIG. 19 illustrates a receiving shared game video cuts process flow;

FIG. 20 illustrates a searching and query process flow;

FIG. 21 shows a maintain directory and games schedules process flow;

FIG. 22 shows a mapping video editor fields process flow;

FIG. 23 is a table of phase II requirements; and

FIGS. 24 through 49 are various user interfaces produced by the system incorporating the functionality of the various user functions.

The detailed description that follows describes one or more particularly preferred embodiments of the present invention. The figures disclose various user interface screens that illustrate the functionality of the present invention. The user interface screens or screen-shots provide a tangible basis for understanding how a user can navigate through the system to upload video or other data, to view data such as videos or player information, as well as to share particular video selections by distributing them to third parties who may wish to view them.

### DETAILED DESCRIPTION

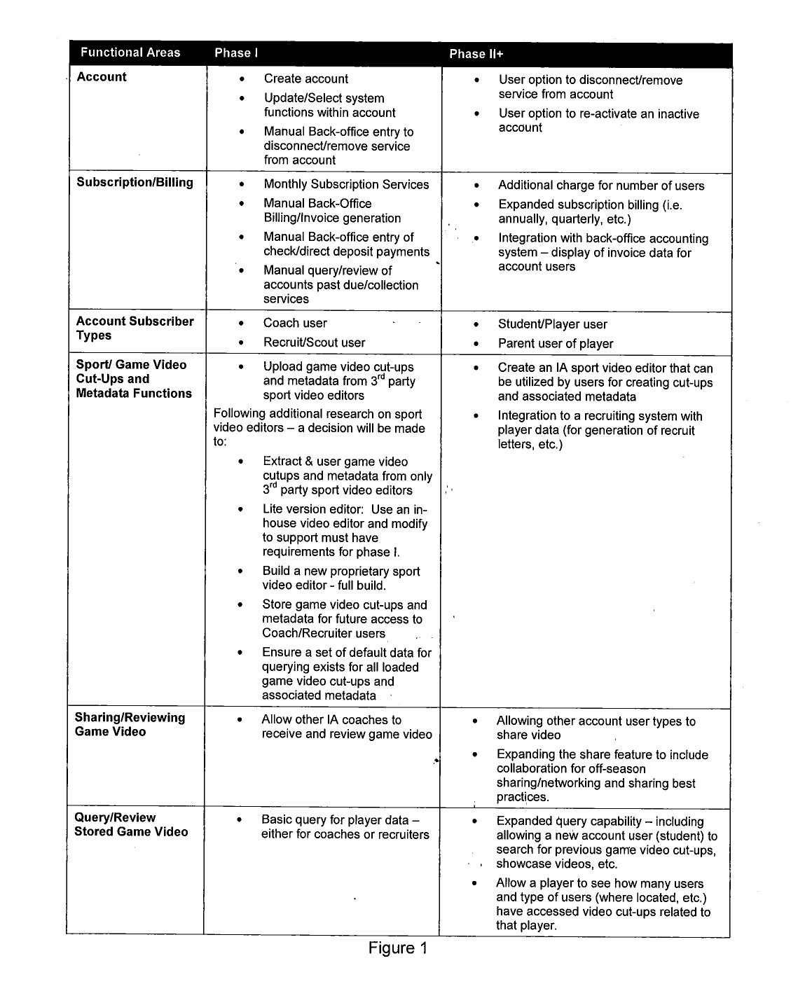

The present invention can be conceptually divided into functional areas, and phases or steps associated with the functional areas. FIG. 1 lists these aspects of the invention in a table format as shown. Each of these functional areas are discussed in more detail below.

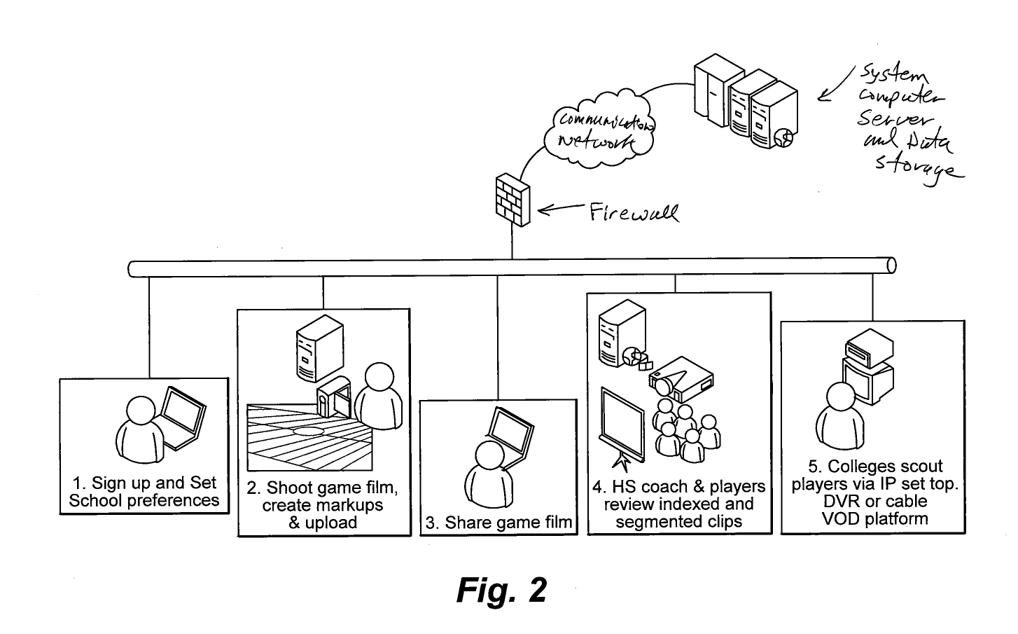

FIG. 2 depicts an overall system view of how the two subscriber types, coaches and recruiters, interact with the system of the present invention. As shown, the system of the present invention may reside in one or more servers/computers that provide data to a website accessible over a communications network such as the Internet. A conventional firewall may be used for protection of user computers. A user is shown signing up, and then later uploading game film. The user then can later share the game film. Other groups such as coaches and players review selected clips. Other users such as recruiters can review other selected clips. Each of the users log into the system and access the website in order to select the functions desired.

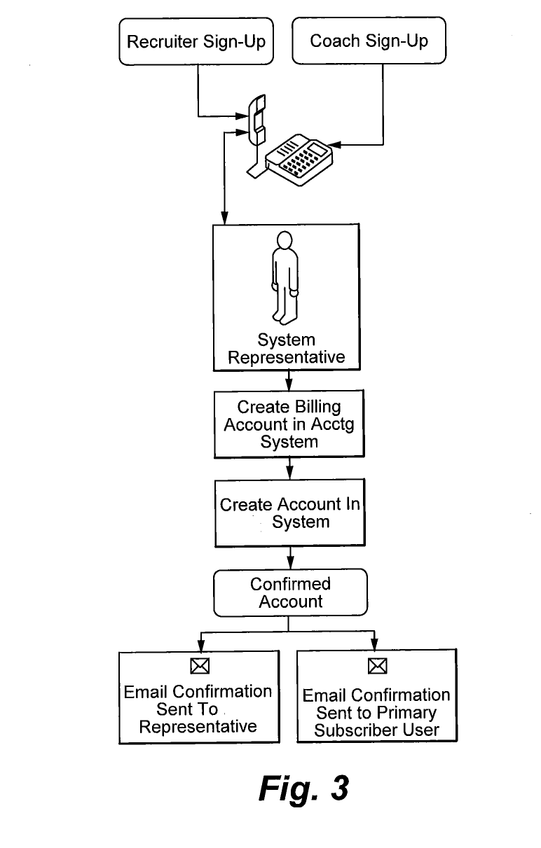

FIG. 3 describes the sign-up process for either a coach or recruiter. The process is as follows: (a) The subscriber contacts central service to discuss his/her needs and the central service representative creates an account in both a 3^{rd} party accounting system and the central service host system. b) Following the initial creation of the account, the primary subscriber user accesses his/her account through the main website to update and to process final registration. The primary subscriber user can create additional (secondary) coach/recruiter(s), reviews general account/school information and confirms the legal agreement associated to the account. c) After the final registration of the account, the subscriber user depending on account subscriber type (coach or recruiter), has access to his/her system account. The following flow describes the system functions available based on account subscriber type.

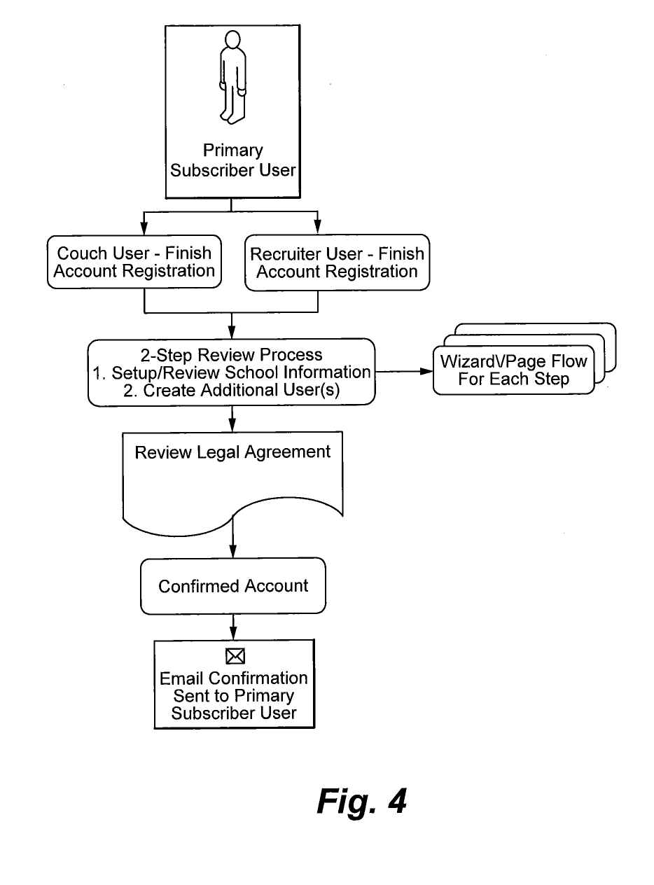

FIG. 4 describes completion of registering an account.

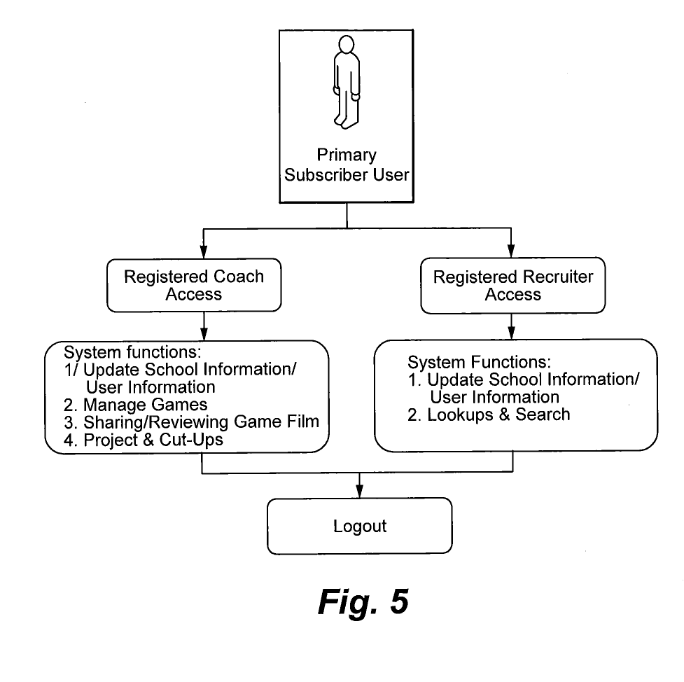

FIG. 5 lists some of the functions available for different system users, for example, coaches and recruiters.

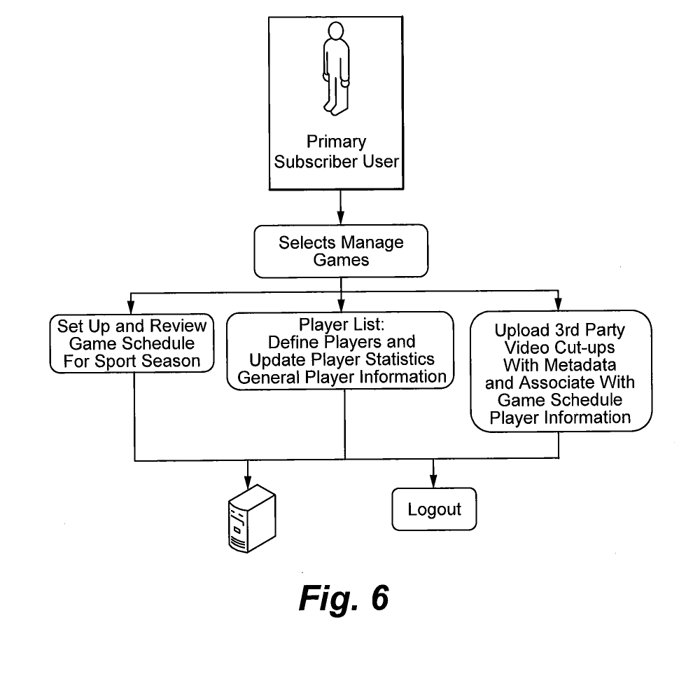

FIG. 6 gives a high-level overview of the different system functions available to system and/or subscriber users of the central service system. The manage games function gives authorized users the capability to: (a) Set up Game Schedules for the associated sport and season (b) Define one or more players to be associated to the games and game video cut-ups and (c) Allow upload of 3^{rd} party game video cut-ups for storage in the central system hosted environment.

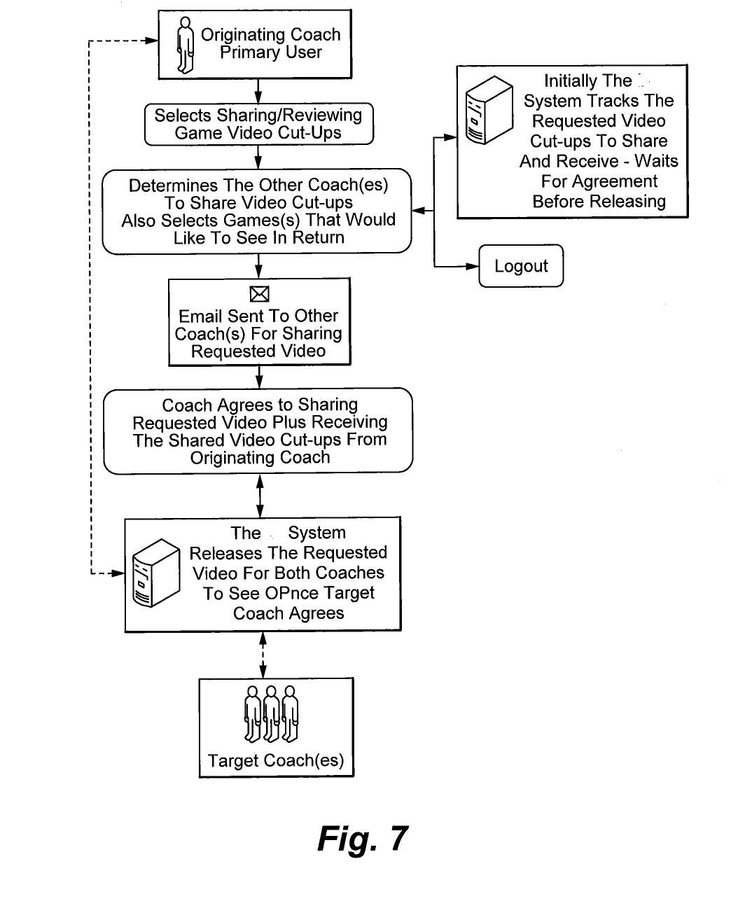

FIG. 7 shows the sharing and reviewing game video cut-ups function that gives authorized users the capability to: (a) Share game video cut-ups with other coach(es); (b) Request video cut-ups to receive in return and (c) The shared video doesn't become available until both coaches agree on the video cut-ups to share and receive.

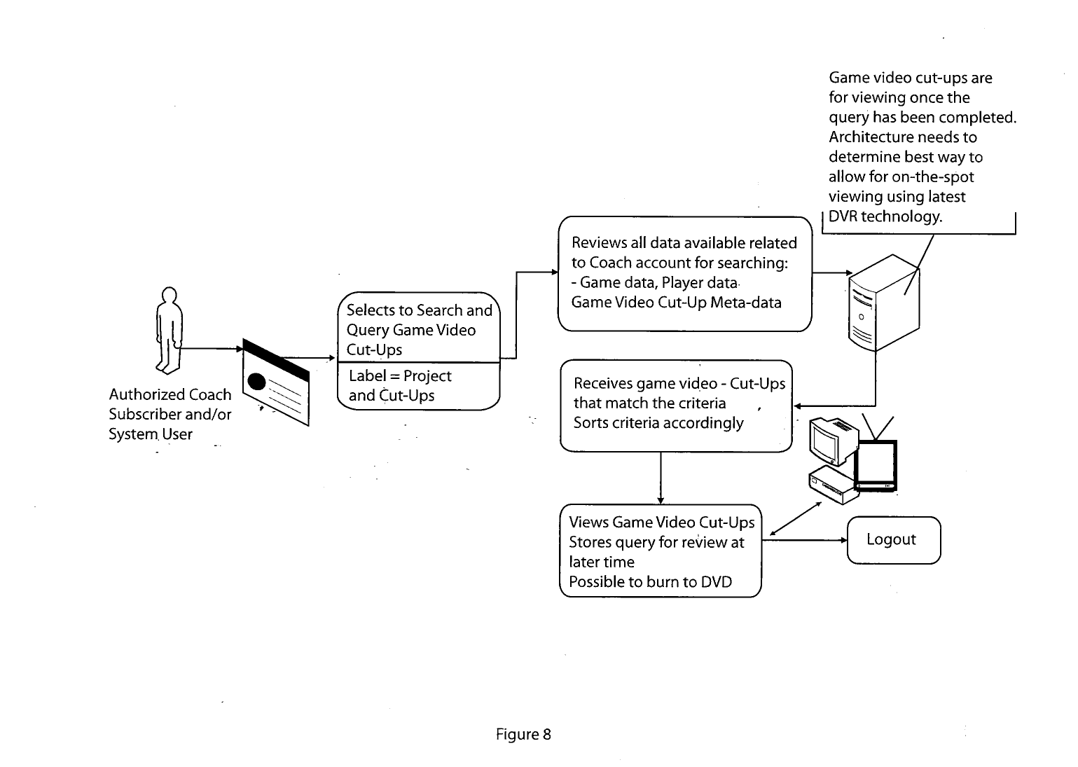

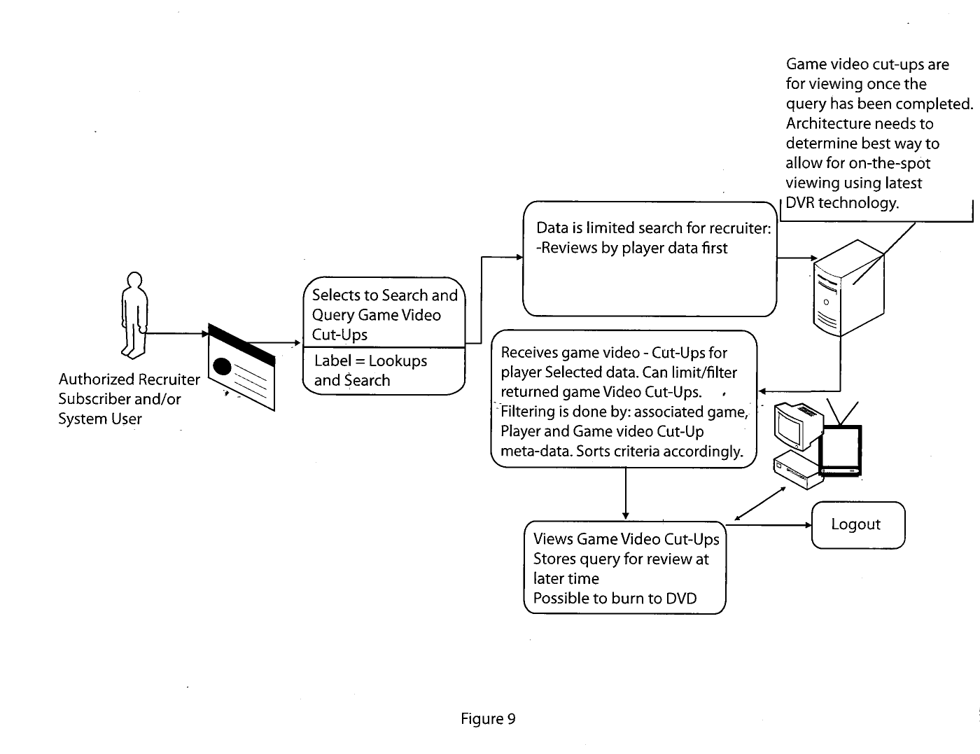

FIG. 8 shows that the search and query game video cut-ups function that gives authorized users the capability to: (a) Search for specific group(s) of game video cut-ups; (b) Sorts and stores query for later retrieval; and (c) Review and play back game video cut-ups using DVR/IPTV technology. Note that the label/designation of this function is different depending on account subscriber type: For use by coaches, the label/designation is Project and Cut-Ups. For use by recruiters, the label/designation is Lookups and Search. Accordingly FIG. 9 shows the search and query game video cu-ups function for lookups and search.

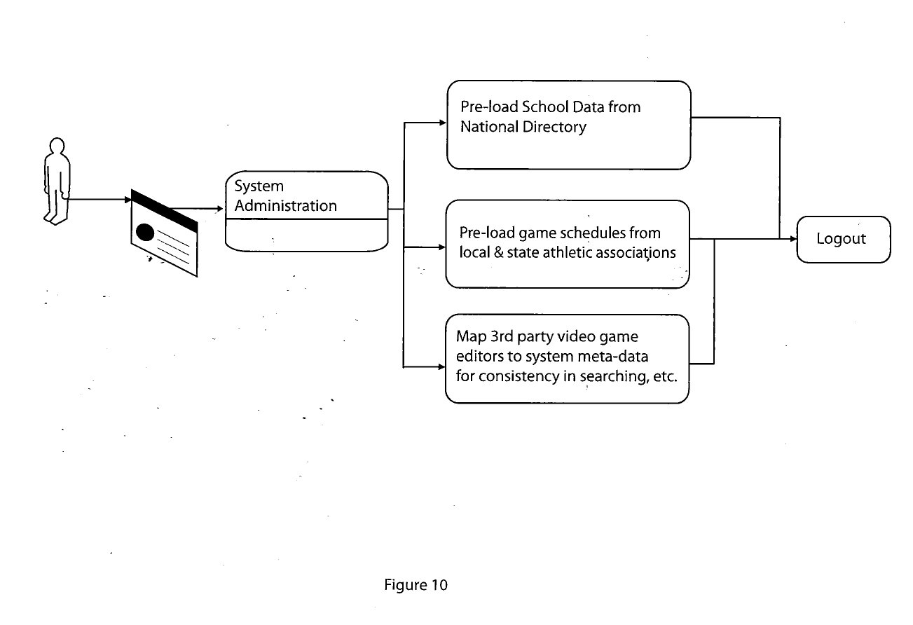

As shown in FIG. 10, the system administration function gives authorized system users the capability to: (a) Pre-upload school names and addresses from a national directory—this eases in the account creation process; (b) Pre-upload game schedules from local and state athletic associations—this eases in the game schedule set-up; and (c) Create mapping of other 3^{rd} party video game cut-up editors to a standard format—this allows all data that is searched to follow a standard; eases the search functions for the users.

The following table provide definitions of terms:

| | Definition |
|---|---|
| Acronym | |
| DVR | Digital Video Recorder |
| Term | |
| Account | School name plus account subscriber type identifies an account |
| | and the behavior of that account in the central service System. |
| Account Subscriber Type | The category of an end consumer paying for |
| | central service hosting services. For Phase I - two |
| | account subscriber types are supported: Coach or |
| | Recruiter. Additional phases request expansion of |
| | the number of account subscriber types supported |
| | by the central service System. |
| Game Video | The entire length of moving picture (video) for a |
| | game. A game video can be marked into game |
| | video cut-ups. |
| Game Video Cut-Ups | Moving pictures (videos) of sport related activities. |
| | These videos can be marked and edited into |
| | sections and/or be an entire sport event. Each |
| | video cut-up has a set of metadata describing the |
| | starting and end results of that segment of video. |
| Central Service System User | An internal employee of central service that is |
| | accessing account or other system functions within |
| | the central service System. |
| Central Service System User Type | Further classification of the central service |
| | employee using the system. Examples of central |
| | service system user types: administrative users, |
| | account representatives, sales representatives, etc. |
| Originating Coach | The primary subscriber user for coach accounts |
| | that starts the process for sharing game video cut- |
| | ups. |
| Primary Subscriber User | The end consumer responsible for creating the |
| | account, paying any outstanding invoices for the |
| | account and is the main contact for an account. An |
| | account can only have one primary subscriber user. |
| Recruiter | A potential subscriber that scouts sport players. |
| | Requires reviewing cut-up game videos to find the |
| | next best sport talent for sport. |
| Secondary Subscriber User | The end consumer NOT responsible for the |
| | account. These users exist to allow other |
| | department members of the same account |
| | subscriber type to have access to the main |
| | functions within the central service system. |
| | Examples of secondary users: offense coach, |
| | defensive coach or offense recruiter, special teams |
| | recruiter, etc. |
| Subscriber User | The end consumer of the System. A subscriber |
| | user can be either primary or secondary. |
| Target Coach | The receiving primary subscriber user for another |
| | coach account. This coach is requested to |
| | reciprocate the originating coach's request for |
| | shared game video cut-ups. |

It may be understood that many different sports are supported by the methods and systems of the present invention. Although football is shown in the examples, other sports can be included such as men/women basketball, men baseball, women softball, men/women soccer, men/women lacrosse, men/women hockey, etc. All defined requirements support the intention of the present invention to offer more than one sport.

If a subscriber user is responsible for more than one school, the subscriber user may need to create a separate account for each school.

If the subscriber user is responsible for both the recruiting and the coaching of a school, the subscriber user needs to create a separate account for each activity (coaching=1 account/recruiting=1 account).

The present invention can manually terminate any account upon request. This is a manual process and this use case is not within these requirements.

A legal agreement may be required for the subscriber user to finish his/her registration.
i) coach legal agreement can be the same or different from the recruiter legal agreement.
ii) central service ensures that each legal agreement has verbiage to have the school take responsibility for student legal agreements regarding videos of those students loaded and hosted within the central service system.
iii) the central service manually works with any account that does not accept the legal agreement as part of the account registration process.

The present invention creates a security process to assist those primary subscriber users that forget username and/or password.

User display and central service website marketing details can be tailored for a specific customer base.

The titles and display for the searching/querying capabilities can be distinct per subscriber user type. One set of requirements support the search & query capabilities offered to both subscriber user types.
i) Project & Cut-Ups=Label provided for searching/query capabilities for a coach subscriber type
ii) Lookups & Search=Label provided for searching/query capabilities for a recruiter subscriber type

With respect to billings, the central service may include a third party accounting system that is responsible for all billing and general accounting functions. The details of an invoice and/or related charges may or may not be accessible from the central service system to the subscriber user.

Monthly and one-time fees can be entered by the central service back-office into a 3^{rd} party accounting system.

Additional billing back-office functions can support:
i) Entry of check/direct deposit payments from purchase orders.
ii) Monthly review of accounts for those accounts that have not paid/not paid in full for services. Any collection letters, phone calls, etc. can be monitored and tracked in the 3^{rd} party accounting system.

Coaches can populate the player list with the players that he/she wishes to highlight/showcase. It is possible that the coaches may input the entire player roster, but it is assumed at a minimum, the player list can contain the showcase players.

For the first phase, if a player wishes to be showcased, a coach could create a separate payment option to allow the player to exist alongside the other showcased players. This payment option would exist between the player and coach until the secondary phase of requirements is implemented supporting a unique account for players that wish to have their own account.

When sharing game videos for a particular game name all game video cut-ups and related meta-data is sent to target coach.

Both the originating sharing coach and target coach can have already created queries that quickly access the game videos for intended sharing.

If two coach primary subscriber users cannot come to an agreement regarding shared game video cut-ups and related metadata, the central service can offer a manual process to resolve sharing the game video cut-ups as needed. This includes sending video cut-ups to coaches that have yet to register within the central service system.

School information can be pre-populated by the present invention on a regular interval (e.g. annual, quarterly, etc.) into the central service system for establishing new accounts. This school information can be downloaded from the Clellwades directory, or something similar.

Game schedules can be pre-populated into the database for review by users. This information can be retrieved from the associated athletic association (High School Association for State, College Association for State, etc.)

Phase I implementation can support receiving 3^{rd} party game video cut-ups and marked metadata. It is assumed that the edited game video cut-ups created by other 3^{rd} party game video editors has metadata that can be extracted and stored within the central service system.
i) The central service system can store the metadata to the associated game video cut-ups uploaded from the 3^{rd} party vendors. This data is to be part of the search criteria and displayed with the query results established by all account subscriber types.
ii) Player data cannot be part of any metadata associated to game video cut-ups received from 3^{rd} party sport video editors.

Phase I implementation can decide on the best method for implementing the first phase of a central service video editor. This implementation could be one of the following implementations: (i) Using only 3^{rd} party video editors and uploading game video cut-ups and related metadata for each game video. (ii) Creating a light version of the editor. This would require using an already existing in-house editor and updating the editor to support must-have requirements for phase I. This would be in addition to accepting the 3^{rd} party video editors. iii) Building a complete video editor, in addition to accepting 3^{rd} party video editor formats.

User credit card authorization can occur during the setup of the account. This may require an interface to a credit card vendor.

System data can be data driven and architected to allow for expanded offerings for future phases.

Central service system functions can offer print screen possibilities. Specifically the system and/or subscriber user should be able to print: game schedules, player information, shared game videos and queries.:

Architecture of sport specific data allows data fields reuse for multiple sports. Then, dependent on sport defined for player and/or game, the correct label be displayed. This architecture design ensures that the system of the present invention can grow and support additional sports without causing re-architecture.

### Logical Example of Data Design

| Data Field | Associated Sport | Label |
|---|---|---|
| Data 1 | Football | 40-yd dash speed |
| Data 1 | Baseball | RBI |

Further definition of the metadata associated to 3^{rd} party vendors is required. Investigation of similar named fields between all systems, and even those data fields that are custom to the 3^{rd} party vendor need to be fully identified. A standard interface can be defined to map all similar fields, and custom fields to a “standard” video editor/cut-up and metadata system.

For sharing game videos and related game video cut-ups, the system should have a defined shared video viewing time limit that applies to all shared game videos. For example, a time limit could be equal to the length of the game season for sport.

The architecture of the query and search function considers large, medium and small queries against all video data stored in the central service system.

The system can be architected to ensure that a user utilize an IP based network with DVR/TiVO/On Demand hardware to view game videos and related game video cut-ups.

Any user type should be ensured to execute the following functions from a remote when reviewing game video cut-ups: (a) Fast Forward—3 speeds (b) Rewind—3 speeds (c) Pause (d) Stop (e) Play (i) Regular speed or (ii) 2× regular speed (f) Slow motion—per frame and/or by 1-second intervals (g) Slow motion capabilities in either Fast Forward or Rewind

Any user type has the capability to burn game video cut-ups and related metadata to a DVD.

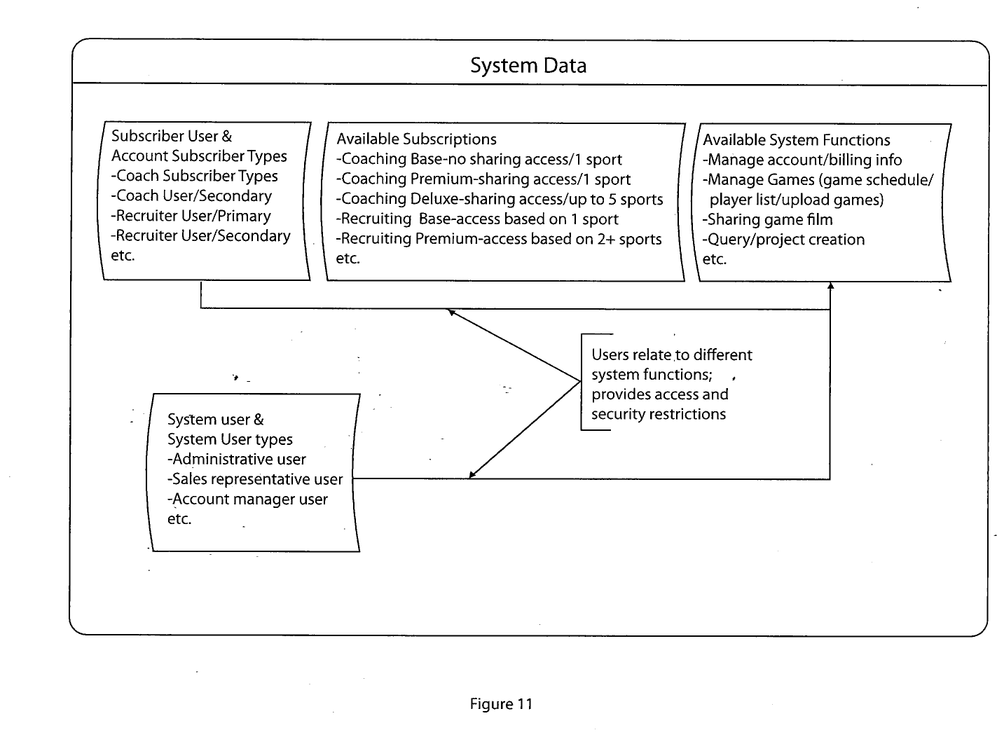

FIG. 11 shows the account structure for the central service system to offer hosted subscription services.

The system of the present invention allows for the following system functions: (a) School Account Information and User Information; (b) Manage Games—

(i) Manage Games Sub-Function—Create/Manage Game Schedule

(ii) Manage Games Sub-Function—Create/Manage Player List

(iii) Manage Games Sub-Function—Uploading Game Video Cut-Ups

(c) Sharing and Reviewing Game Video Cut-Ups; (d) Searching and Query—

(i) Label for Coach Subscriber Type=“Project & Cut-Ups”

(ii) Label for Recruiter Subscriber Type=“Lookups & Search”

(e) System Administration

The system of the present invention allows for the following different system users: (a) Central service system user—
(i) Each system user should belong to one or more system user types. (account representative, administrative user, system interface user, etc.)
(ii) The following data fields are required for each central service system user: (1) System user first name; (2) System user last name; (3) System user email address; (4) System user main contact phone number
   (b) For subscriber users
(i) A central service subscriber user is only one of the following:
   (1) Primary subscriber user
   (2) Secondary subscriber user
      (c) The present invention ensures that all system and subscriber users can:
(i) Login to the central service system using username and password
(ii) Logout of the central service system

The present invention defines the access allowed for each system user by associating the system user to one or more system functions. Embodiments of the present invention can allow for an additional system function to be defined per system user: Central service system user to enable or disable central service system functions for an account.

Embodiments of the present invention allow for the following different subscriber account types: (a)

Coach subscriber type; (b) Recruiter subscriber type

Embodiments of the present invention allow for the definition of 1-n subscriptions.

(a) A subscription consists of:
(i) Subscription name
(ii) System start date for subscription
(iii) System end date for subscription

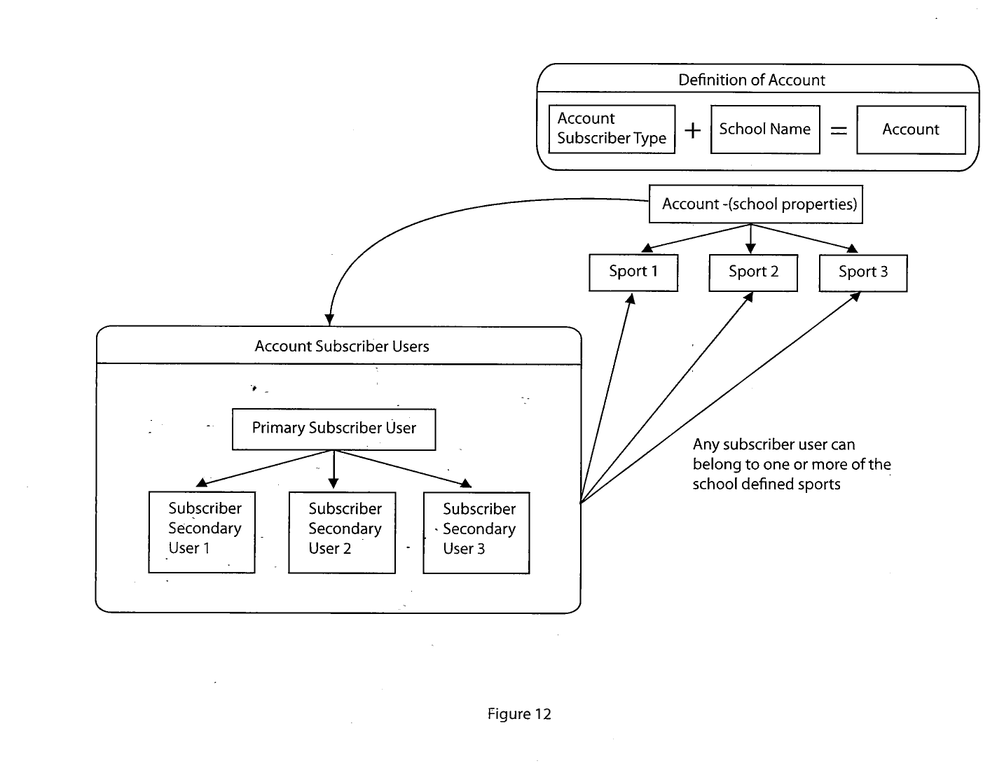

(b) Subscriptions should not be available for selection if the:
(i) System subscription start date is greater than current date
(ii) System subscription end date is less than current date
   FIG. 12 shows an account data overview. Embodiments of the present invention allow 1-n accounts to exist within the system.

(a) An account is equal to the school name plus subscriber type associated to the account.
(i) More than one account can have the same school name.
(ii) More than one account can have the same subscriber type.
(iii) More than one account can have the same school name and subscriber account type.

(b) A unique identifier should exist to distinguish each account, regardless if the accounts share the same school name, subscriber user type or both attributes.

(c) An account may have an account status of either:
(i) Active
   (1) An account is “active” when subscribing to one or more defined subscriptions.
(ii) Inactive
   (1) An account is “inactive” when subscribing to no subscriptions.
      Embodiments of the present invention can set a default for the available functions for an account based on account subscriber type.

(h) An account with a coach subscriber type should have the following system functions defaulted:
(i) School Account Information and User Information
(ii) Manage Games (Game Schedule, Player List and Uploading Game Video Cut-Ups)
(iii) Sharing and Reviewing Game Video Cut-Ups
(iv) Searching and Query (Label for Coach Subscriber Type=“Project & Cut-Ups”)

(a) An account with a recruiter subscriber type can have the following system functions defaulted:
(i) School Account Information and User Information Searching and Query (Label for Recruiter Subscriber Type=“Lookups & Search”)

Embodiments of the present invention allow a system user to flag an account for delinquency.

(a) This flag should display to the primary subscriber user within the account information if the flag equals “yes” for delinquency.

This section defines the sign-up process and configuration of an account within the hosted central service system. The sign-up process is a two-step process:
Step 1: This is the initial contact of a potential subscriber user. Upon the subscriber speaking to a central service representative, the representative can configure the initial account information within two systems:
The central service system
A 3^{rd} party Accounting system
Step 2: The subscriber user receives an email from step 1 asking the subscriber to finalize his/her registration with the central service. This step allows the subscriber to review information input by the central service representative, update and add additional users to the account and review/accept the legal agreement associated to the account. Once accepting the agreement, the subscriber has finalized his account.

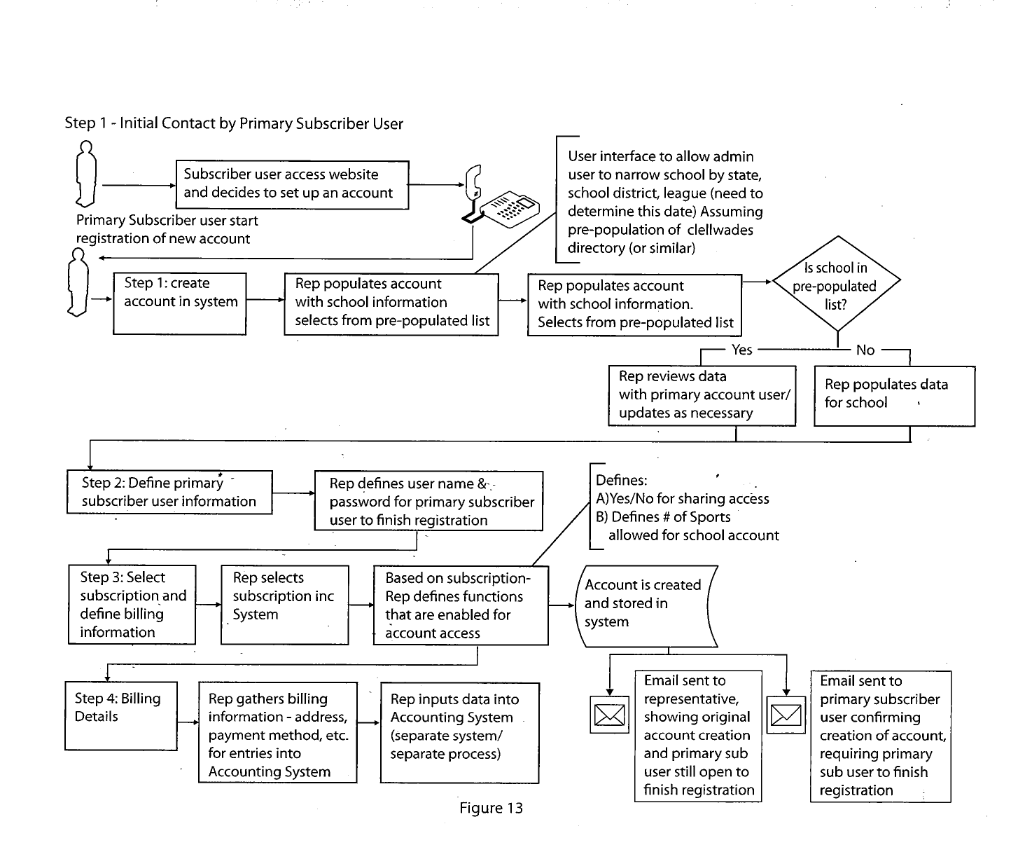

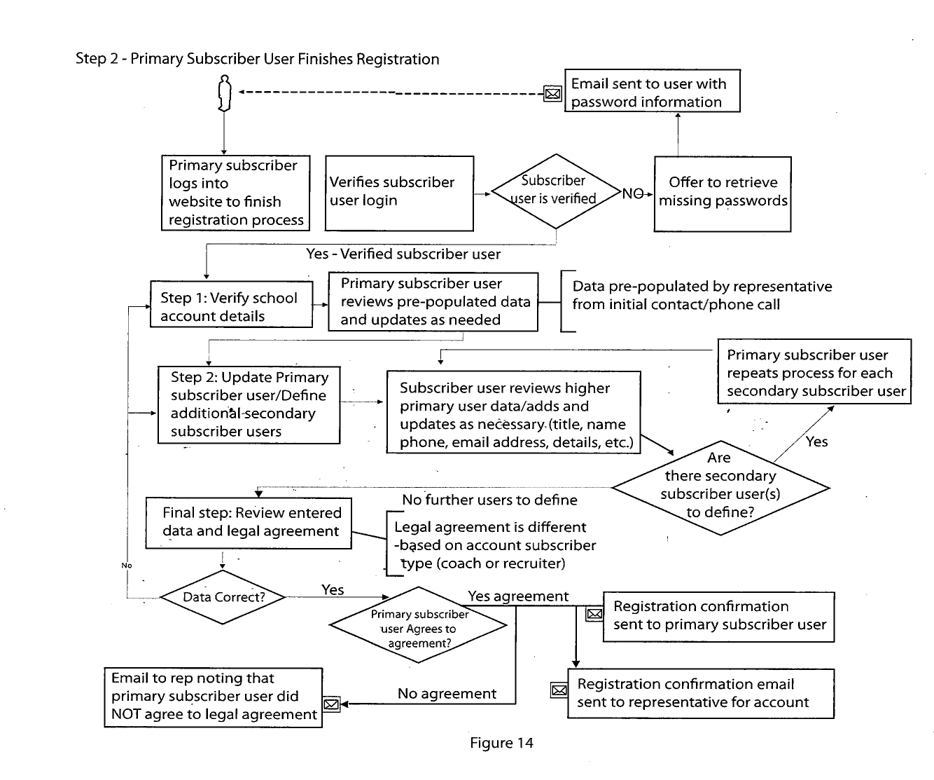

FIGS. 13 and 14 show the process in creating an account and finishing setup of the account.

Embodiments of the present invention ensure that a central service system user starts the account creation process.

The sign-up and configure account option of the central service system can have four sub-sections:

(a) Section 1: Establish school information

(b) Section 2: Establish account user information

(c) Section 3: Subscription and access configuration

(d) Section 4: Review account and legal waiver

Embodiments of the present invention ensures access to the account sub-sections based on user type:

(a) A central service system user should have access to the following functions:
(i) Section 1: Establish school information
(ii) Section 2: Establish account user information
(iii) Section 3: Subscription and access configuration

(b) A subscriber user should have access to the following functions:
(i) Section 1: Establish school information
(ii) Section 2: Establish account user information
(iii) Section 3: Review account and legal waiver
   Embodiments of the present invention record the central service system user creating the account.

To establish a school account, the user, regardless of user type, is required to fill out the following school information:

(a) Select from a list of all possible schools
(i) Allow user to filter for pre-populated schools by one or more of the following:
   (1) State
   (2) City
   (3) Zip
   (4) League
(ii) Each filter criteria can be alone or used in combination (“and”) with other populated filter criteria.
(b) School name; (c) School street address; (d) School city; (e) School state; (f) School zip; (g) School main phone number; (h) School district; (i) School league; (j)
School classification (6A,5A, etc.-/8-man football); (k) School sport(s) supported; (i) 1-n school sports can be defined

Additional school details—optional information for population by user:

(a) School main fax number; (b) School central e-mail address; (c) School system address

Embodiments of the present invention require that each school account have a designated primary subscriber user. (a) Any user type can establish subscriber user information.

To establish a primary subscriber user, the following information if required:
(a) Primary subscriber user first name; (b) Primary subscriber user last name; (c) Primary subscriber user title; (d) Primary subscriber user's sport(s): (coached or recruited)—
   (i) All sports available for selection are limited to the sport(s) defined for the school.
   (ii) A primary subscriber user must be related to at least one sport
      (1) If the school for the subscriber has more than one sport defined then a primary subscriber user definition can include more than one sport.
(e) Primary subscriber user email address; (f) Primary subscriber user main phone contact number; (g) Primary subscriber username=email address; (i) Usernames are preferably matched to the user's email address.
   (ii) All usernames must be unique.
(h) Primary subscriber password
   (i) Primary subscriber security question—to retrieve forgotten password

Additional subscriber user details—optional information:

(a) Mobile phone number

(b) Fax phone number

(c) Bio information
(i) Bio information is text based

Each account can have 1-n secondary subscriber users defined.

(a) For each secondary subscriber user the same user information is required/optional as identified for the primary subscriber user.

To establish a school account the central service system user fills out the following information:
(a) Select a subscription from available offerings
(b) Review system functions defaulted for account (based on account subscriber type)
   (i) All system functions should be defaulted as enabled.
   (ii) The central service system user can enable or disable any system function defaulted for an account.

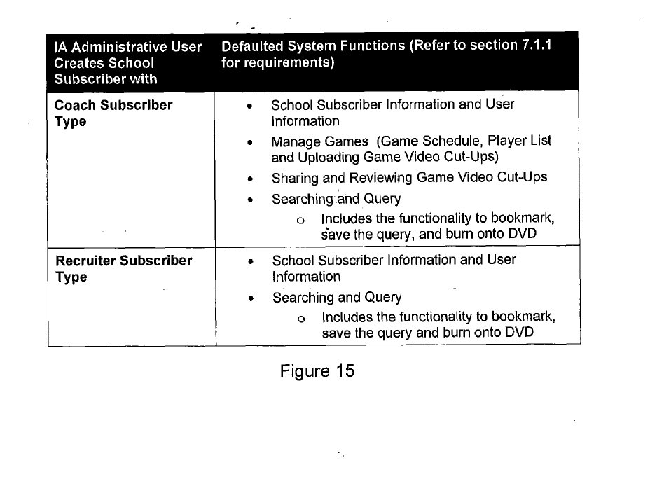

FIG. 15 shows examples of detailed system functions.

Embodiments of the present invention ensure that once an account is initially created an email requesting account confirmation and review of the legal agreement is sent to:

(a) The primary subscriber username (email address)

(b) The central service system user's email address that initially created the account.

A primary subscriber user can update any information in previous sections as needed.

To establish a school account, the subscriber user is required to fill out the following account information:

(a) Legal agreement
(i) There may be a different legal waiver based on the account subscriber type associated to the school account.
   (1) Legal agreement for coach account subscriber type
   (2) Legal agreement for recruiter account subscriber type

(b) Only the primary subscriber user can review and accept/decline the legal agreement
(i) If the primary subscriber user accepts the legal agreement, an email confirmation of account number and enabled functions is sent to the following:
   (1) Primary subscriber user's email address for account
   (2) The central service system user's email address that created the account
(ii) If the primary subscriber user declines the legal agreement, an email noting that the legal agreement has not been accepted is sent to the following:
   (2) The central service system user's email address that created the account

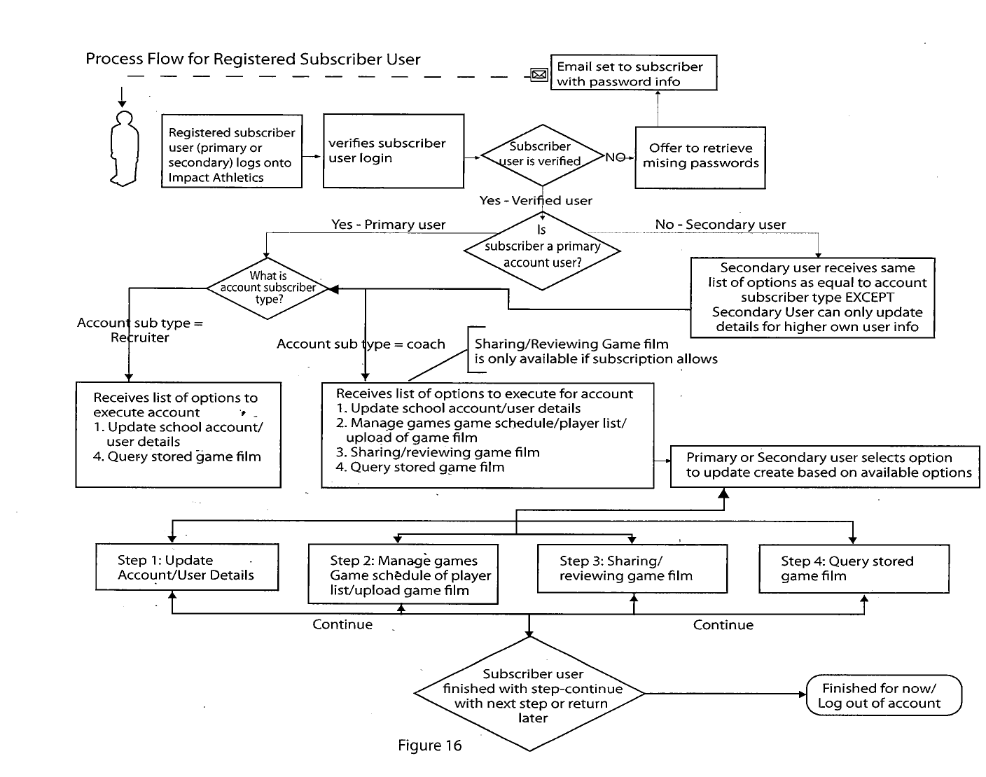

This section describes the requirements for general access to system functions for a subscriber user. FIG. 16 shows the process for a registered subscriber user.

Embodiments of the present invention validate the username and password to allow user access to system functions.

(a) If the username and password do not match an account's primary subscriber user in the central service system, the system can reject the login.

(b) If the central service system recognizes the account primary subscriber username but not the password, the central service system can ask if user would like password sent by email.
(i) If the user requests yes to email notification of password, primary subscriber user must answer the associated security question correctly.
   (1) If the answer to security question is correct, the central service system sends the primary subscriber user's password by email.
   (2) If the answer to security question is incorrect, the central service system refuses login to attempted primary subscriber user.
      Embodiments of the present invention ensure that any primary subscriber user can access and update any field within:

(a) School account information

(b) User information—for all primary and secondary subscriber users defined.

The primary subscriber user can add or remove secondary users.

Embodiments of the present invention ensure that any secondary user only has access to his/her own user information.

No information within the system function “School and User Information” be accessible for a secondary subscriber user regardless of account subscriber type.

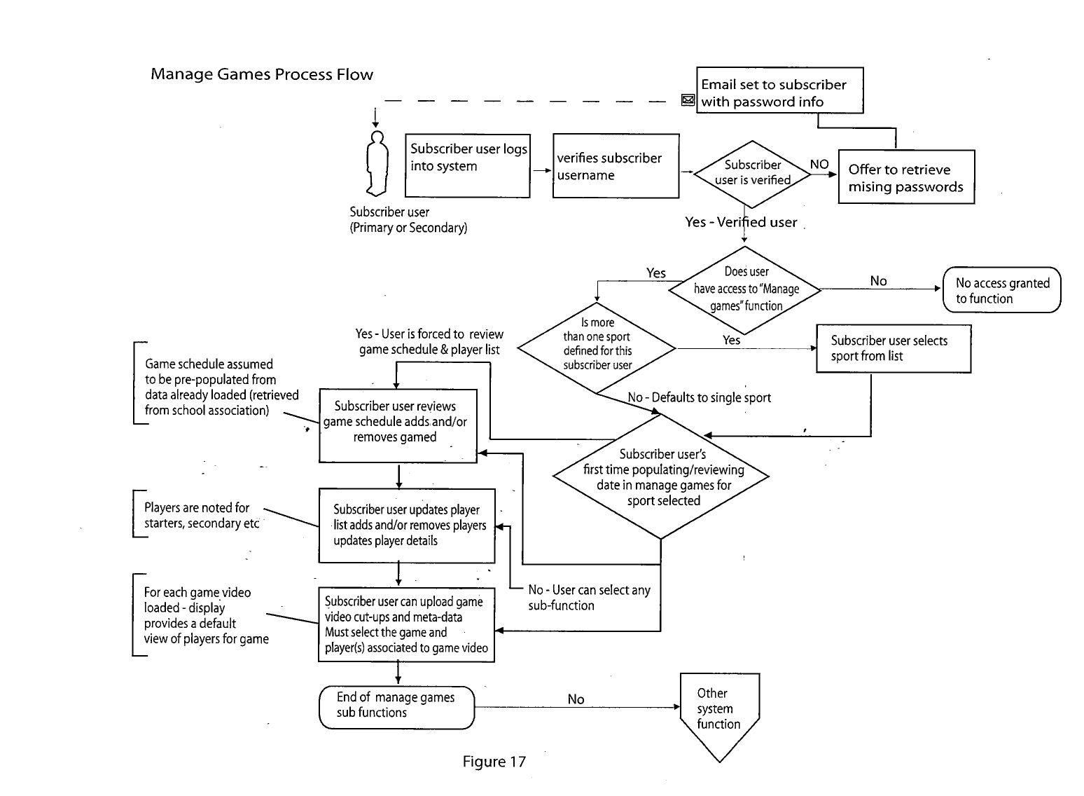

This section describes the requirements for the system function “Manage Games” and its related sub-functions for a subscriber user. FIG. 17 illustrates the process flow for managing games.

Embodiments of the present invention allow any subscriber user with designated access to the “Manage Games” system function.

a) The “Manage Games” system function requires the subscriber user to select which sport to manage, if subscriber user is associated to more than one sport.
(i) All sub-functions within “Manage Games” may adhere to the sport selected by the subscriber user.
(ii) The subscriber user has the capability to finish one sport and select another sport to repeat process and reuse of sub-functions.

(b) The “Manage Games” system function includes the following sub-functions:
(i) Manage/Review Game Schedule
(ii) Manage/Review Player List
(iii) Upload Game Video Cut-Ups and Metadata

(c) The Manage Games system function recognizes if the subscriber user is accessing the sub-functions for the sport selected for the first time.
(i) If the subscriber user is accessing the sub-functions for the first time, the subscriber user is required to review the following two sub-functions:
   (1) Manage/Review Game Schedule
   (2) Manage/Review Player List
(ii) If the subscriber user has accessed the two sub-functions for the second or later time, the subscriber user can access any sub-function as needed.
   The Mange/Review Game Schedule sub-function determines if possible to pre-load any game schedules for the sport selected.

(a) Upon pre-loading a game schedule, the subscriber user is required to review that the game information loaded is accurate.
(i) The subscriber user can modify any data field within the pre-loaded game schedule information.
(ii) The subscriber user can add additional games to the pre-loaded game schedule as needed.
(iii) The subscriber user can remove games from the pre-loaded game schedule as needed.

(b) If game schedule does not preload, the sub-function can require the subscriber user to populate at least one game for the schedule.

(c) The subscriber user can populate 1-n games.

(d) The subscriber user can modify any game data field with the game schedule at any time.
(i) The subscriber user can add game(s) to game schedule at any time.
(ii) The subscriber user can remove game(s) from game schedule at any time.
Each game within the game schedule sub-function can have the following information required:

(a) Game season

(b) Home team name

(c) Home team league

(d) Visiting team name

(e) Visiting team league

(f) Game date (month/date/year)

(g) Game scheduled start time (hh:mm)

(h) Game final score

(i) Game results (win/loss)

(j) Game specific box score
(i) The game specific box score is sport specific.
   The Manage/Review Player List sub-function ensures that the subscriber user defines at least one player for the sport selected.

(a) The subscriber user can add 1-n players as needed.

(b) The subscriber user can remove 1-n players as needed.
(i) The system sub-function ensures that at least one player is always defined for sport selected.

Each player within the player list can have the following information required:

(a) Player first name

(b) Player last name

(c) Player street address, city, state, zip
Embodiments of the present invention offer an option for subscriber user to pre-populate player's address details with same as school address details.

(d) Player main contact phone number
Embodiments of the present invention offer an option for subscriber user to pre-populate player's main contact phone number with same as school main phone number details.

(e) Player position for team sport
A player may have 1-n positions defined.

(f) Player gender (male/female)

(g) Player height

(h) Player weight

(i) Player birth date

(j) Player graduating year

(k) Player GPA

(l) Player level (varsity, junior varsity, freshman,)

(m) Player starter? (allow different text definitions for this field—e.g. starter, 1^{st} string, 2^{nd} string, etc.)

(n) Player legal agreement received? (yes/no)

Each player within the player list can have the following information optional:

(a) Player mobile phone number

(b) Player email address

(c) SAT score

(d) ACT score

(e) Player showcase videos
(i) A player can have 1-n showcase videos. Examples of videos: interview video, workout video, custom footage, etc.
(ii) Each player video should have a label associated to the video, describing video file.

Each player may have sport specific data defined for overall player statistics.

(a) Sport specific data relates to each sport season.

(b) Sport specific data repeats for each player position defined where a player has more than one position on the team.
(i) Data fields for Football Sport Specific Data
   (1) Example 1: 40-yd dash speed
   (2) Example 2: Vertical
      The Upload Game Video Cut-Ups and Metadata sub-function allow the subscriber user to access only when the following information is available:

(a) At least one game defined in the game schedule sub-function.

(b) At least one player defined within the player list sub-function.

As part of the process for each game video cut-up uploaded, the subscriber user selects the corresponding game from the game schedule.

As part of the process for each game video cut-up uploaded, the subscriber user reviews the entire player list.
(a) The data field “player starter” is defaulted upon initial load.
(b) The subscriber user is able to modify which player(s) were active from the player list for the identified game intended for upload.

As part of the process for each game video cut-up uploaded, the subscriber user reviews the metadata associated to the game video.

Embodiments of the present invention allow a central service system user with designated access to the “Manage Games” system function.

(a) The same requirements and flow as identified for a subscriber user apply to central service system user(s).

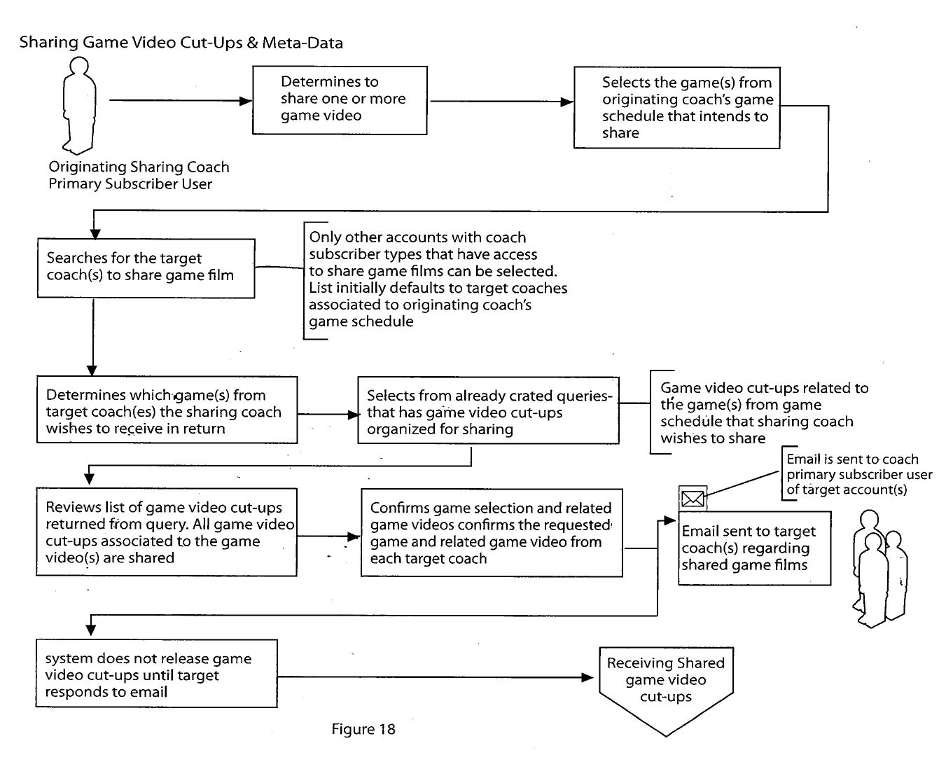

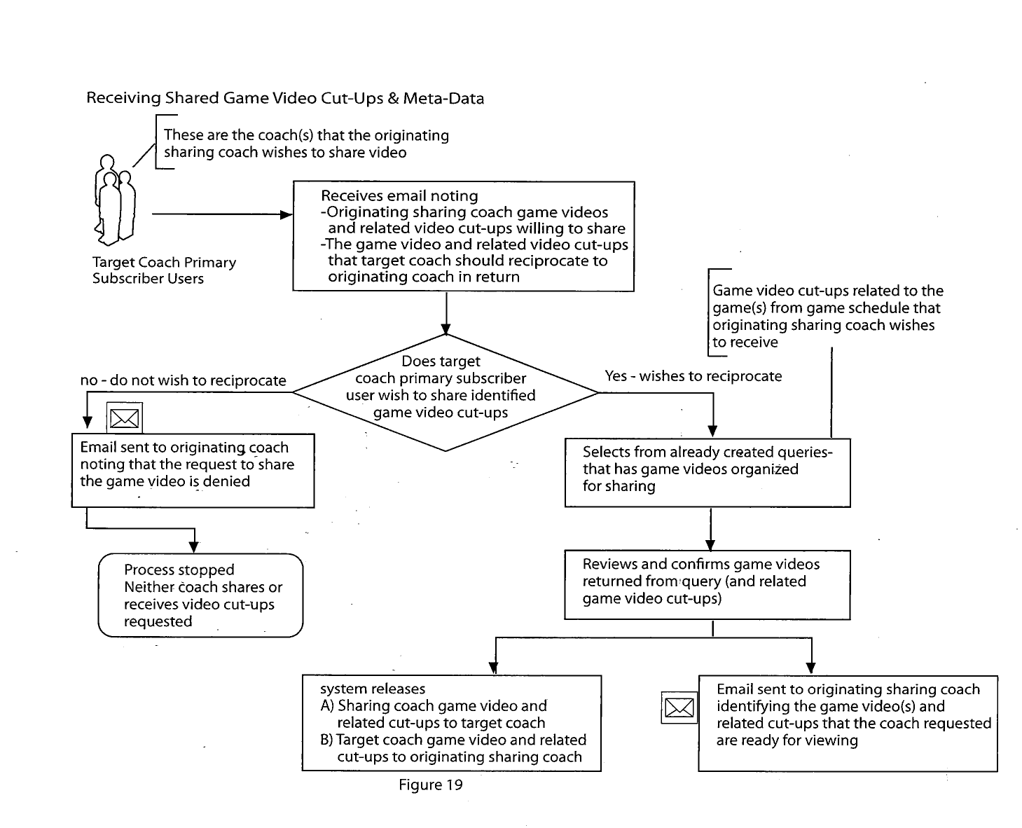

This section details the requirements for sharing and receiving game video cut-ups and Metadata from other central service accounts. For this function, only the account subscriber type of “coach” can participate. FIG. 18 shows the process flow for sharing game video cut-ups. FIG. 19 shows the process flow for receiving shared game video cuts.

Embodiments of the present invention allow an account to share a game video and all related video cut-ups and metadata previously loaded.

(a) Game video sharing is limited to the game video and related game video cut-ups previously loaded and associated to the account.

(b) Embodiments of the present invention can require that only the primary subscriber user have access to share game video.

Video and related video cutups are other accounts.

(a) Only accounts that are account subscriber type=“coach” can receive shared game videos(s).

(b) Only those accounts that have the sharing/reviewing game video cut-ups system function enabled can receive shared game videos.

Embodiments of the present invention can allow the originating coach (primary subscriber user) to search for the reciprocate target coach (primary subscriber user) to receive the game video(s).

(a) The system initially defaults all target coach(es) to the same coaches listed within the originating coach's game schedule.

(b) Embodiments of the present invention allow for additional searching of target coach(es). The search filter includes:
(i) Search by coach first and last name—only primary subscriber users for account subscriber type=“coach”
(ii) Search by school name
(iii) Search by school state
(iv) Search by school city
(v) Search by school league

(c) The search filter may automatically bypass any accounts not of account subscriber type=“coach” and/or do not have access to sharing/reviewing game video cut-ups

(d) One or more accounts with account subscriber type=“coach” are possible to share game videos.

Embodiments of the present invention can require the originating coach selects the following:

(a) The specific game name from his/her game schedule that the originating coach will be sharing.
(i) The originating coach can share game videos for more than one game name.
(ii) Embodiments of the present invention can group game videos for each game shared.

(b) The specific game name from target coach's game schedule that the originating coach would like to receive in return.
(i) The originating coach can request more than one game name (thus more than one game video) from the target coach.
   The central service system can notify the reciprocate target coach by email when the originating coach has declared the shared and requested game video(s).

(a) The email communication is restricted to each account's primary subscriber user.

(b) The reciprocate target coach must share game name(s) and related game video(s) requested from the originating coach.

(c) The reciprocate target coach cannot have access to the shared game video(s) until he/she agrees to share the requested game name and related game video(s) in return.

(d) If the target coach denies the request for the requested game name, the central service system should ensure that no game video(s) are available for viewing by the target coach.

The system may store and track:

(a) Game video requested by originating coach.
(i) Including associated game name
(ii) Including associated game video cut-ups for game

(b) Game video to share to target coach.
(i) Including associated game name
(ii) Including associated game video cut-ups for game

(c) The requested target coach for each game name and related game video/game video cut-ups

(d) The date and time the game video(s) were released for viewing for both:
(i) Originating coach
(ii) Target coach
   Embodiments of the present invention can distinctly identify all game video(s) shared with the primary subscriber user.

(a) The primary subscriber user can delegate the shared game video(s) and related game video cut-ups to one or more secondary users for the account.

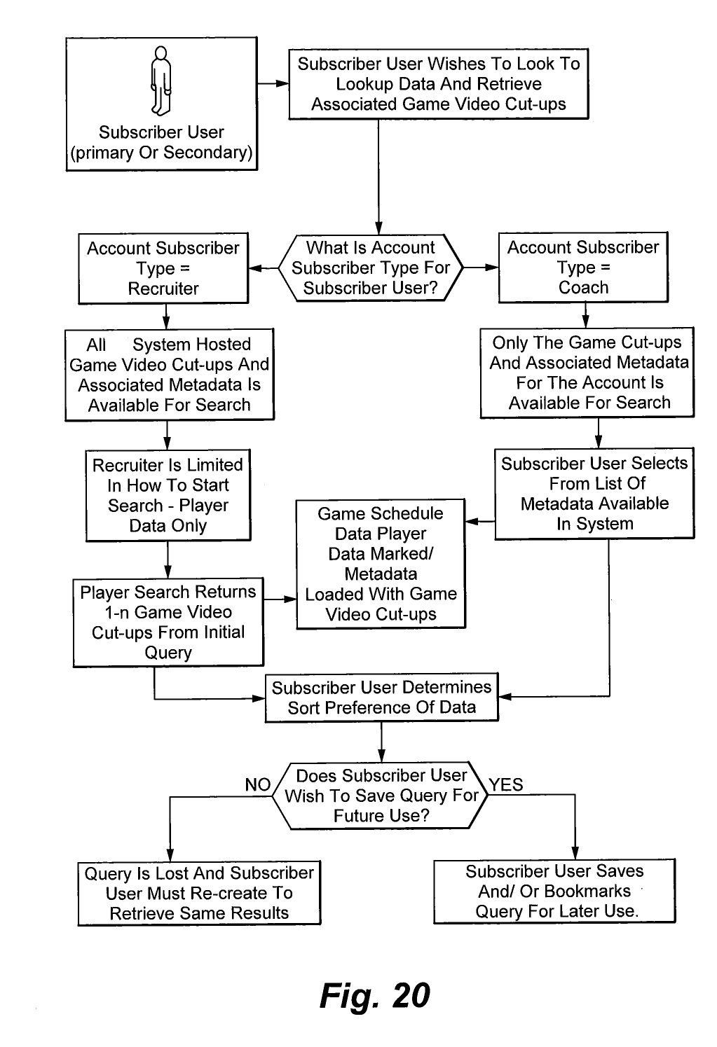

This section describes the requirements for searching and querying all stored data within the central service system. This set of requirements applies to all user types and subscriber users (primary and secondary). FIG. 20 shows the process flow for the searching and query.

Embodiments of the present invention can provide the capability to search and query all stored game video cut-ups.

The system enforces that the account subscriber type for the associated account determines video cut-ups available for searching.

(a) (If the account subscriber type=coach the game video cut-ups available for searching are limited to the video cut-ups associated to the account.

(b) If the account subscriber type=recruiter the game video cut-ups available for searching is all game video cut-ups stored within the central service system.

The system may ensure that the label of the search and query function is different depending on the account subscriber type:

(a) The label for Coach Subscriber Type=“Project & Cut-Ups”

(b) The label for Recruiter Subscriber Type=“Lookups & Search”

The system then searches and queries the following data groups associated to the game video cut-ups:

(a) Game Schedule associated to game video cut-ups—specific data fields for searching

(b) Player data associated to game video cut-ups—specific data fields for searching—

(c) Edit/marked data loaded with the game video cut-ups.

Embodiments of the present invention can differentiate how a subscriber user starts his/her search:

(a) The coach subscriber user starts his/her search with any of the data groups.

(b) The recruiter subscriber user starts his/her search with only the player data group.

(c) Both subscriber users should be able to filter as many times as needed the initial query results by the data associated to the game video cut-ups returned. (game data, player data and video cut-up metadata)

Embodiments of the present invention can allow the subscriber user to:

(a) Play the returned game video cut-ups (associated to the query)

(b) Sort how the display of queried data returns for viewing

(c) Sort the order of display for game video cut-ups, if more than one game video cut-up is returned meeting the same criteria

(d) Save the query for future access; no need to rebuild query after first time
(i) Label the query
(ii) Bookmark the query

(e) Allow the game video cut-ups returned from query to be saved on DVD

(f) The system can keep track of each query per subscriber user, regardless whether the subscriber user is primary or secondary.

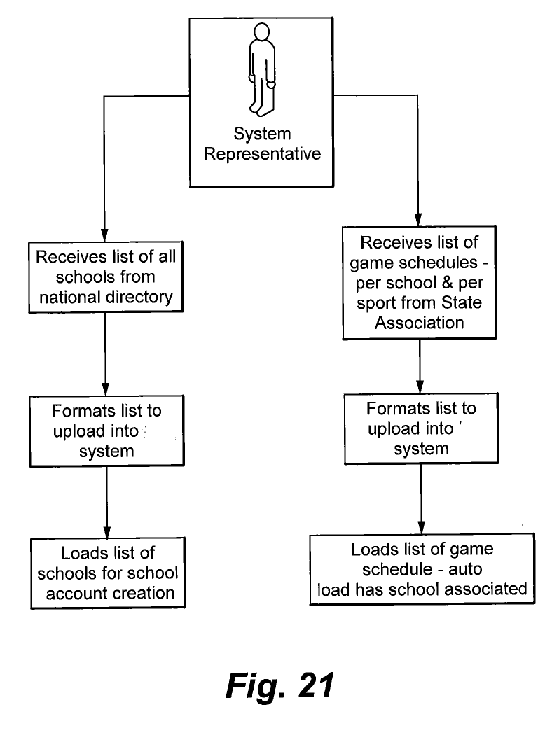

This section identifies the back-office functions that the system needs to perform on a scheduled basis. FIG. 21 shows steps in the process flow of maintaining a directory and games schedule.

Embodiments of the present invention provide an automatic upload of a national school directory.

(a) This school directory populates a list of all possible schools (University, College, High-School, etc.).

(b) This school directory pre-populates school information for new subscribers.

(c) When receiving an updated school list, the list should update any school fields that are not associated to an existing active subscriber.

The system provides an automatic upload of game schedule(s) for each subscriber.

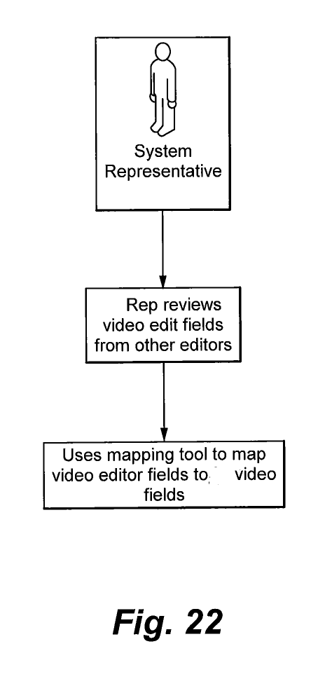

The game schedule may be loaded by:
(i) School name
(ii) School sport
(iii) Game season
   Embodiments of the present invention provide a tool to allow a central system admin user to map 3^{rd} party video editor fields to standard edited fields. FIG. 22 shows the process flow for mapping video editor fields.

(a) The tool allows the central service admin user to define 3^{rd} party field.

(b) The tool allows the central service admin user to determine the central service field that equates to the 3^{rd} party field.

| 3^{rd} Party Field | 3^{rd} Party Vendor | Central Service System Field |
|---|---|---|
| Mark 1 | Coachcomm | Start Mark |
| Side Tight View | XOS | Side View |
| Yards Traveled | Coachcomm | Distance |

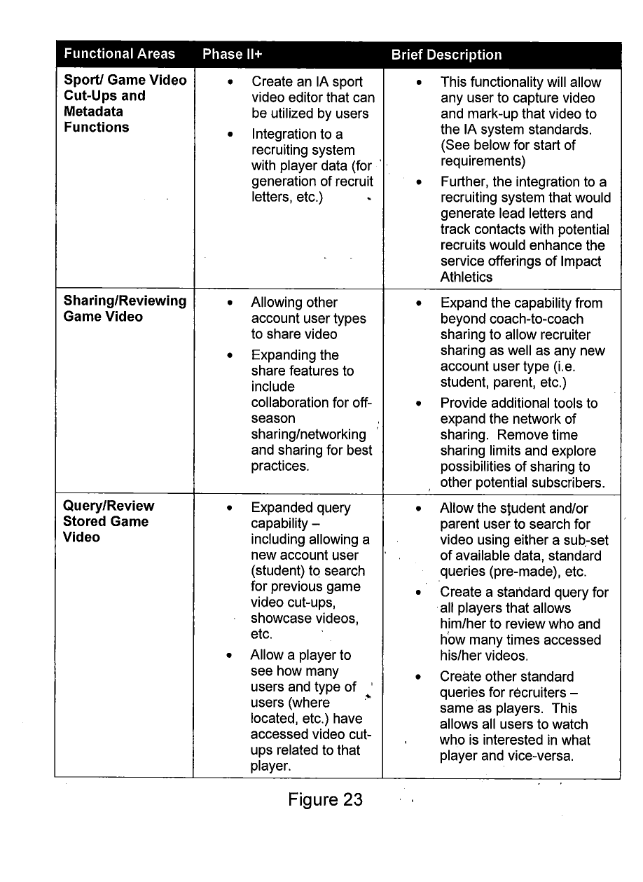

This section provides a brief understanding of the requirements that are for implementation after Phase I. This section is provided for to ensure that Phase I architecture is established to provide for these and other similar functions. FIG. 23 provides a table of listings of the functionality for Phase II.

This section summarizes video editing

First item user: Capture Video

Capture game details

(a) Name of game

(b) Date

(c) Home team vs. Visiting team

(d) Include all details as previously identified

Two views of Game

(a) Side wide

(b) End tight

Can set time limit for game—if unattended

User can capture sessions:

(a) Set and leave—Basic/Static

(b) Mark-on-Fly—Real time editing

(c) Scene Detection—using a digital video camera; detects intervals between start/stop; automatically records the marks. This is the upload “after the game” scenario

(d) Mode Detection—same as scene detection—except done real-time at game

Event editor (event=plays within the video)

User can create templates; define specific data fields

(a) Editor remembers common used terms for data fields; offers a “quick-edit/select” feature

(b) Important for video editor to standardize the data that is available

(c) The user can then create user specific fields to capture personal data

(d) When reviewing game video cut-ups, only the standard fields are available for view by all subscriber types.

(e) The subscriber owner is only user who can view specific fields defined.
(i) Examples of types of standard data (for football):
   (1) Down
   (2) Distance
   (3) Type of plays
      (a) Offense
      (b) Defense
      (c) Special teams
   (4) Personnel
      (a) Backs
      (b) Receivers
      (c) Front
      (d) Coverage

Different speeds to review and capture data

(a) FF/Rev—in one second intervals

(b) FF/Rev—one frame at a time ( 1/30^{th} of a second)

(c) Pause

(d) Play

(e) Stop

(f) Zoom capabilities

(g) Volume capture

(h) Overall speed
(i) ¼
(ii) ½
(iii) ¾
(iv) 1× (regular speed)
(v) 2× (two times reg speed)

For each game video edited, the same game data and player data defined can be associated to game video cut-up(s).

(a) It is important for the metadata associated to an edited game video done in the sport video editor to know which game and players were associated to the mark-ups.

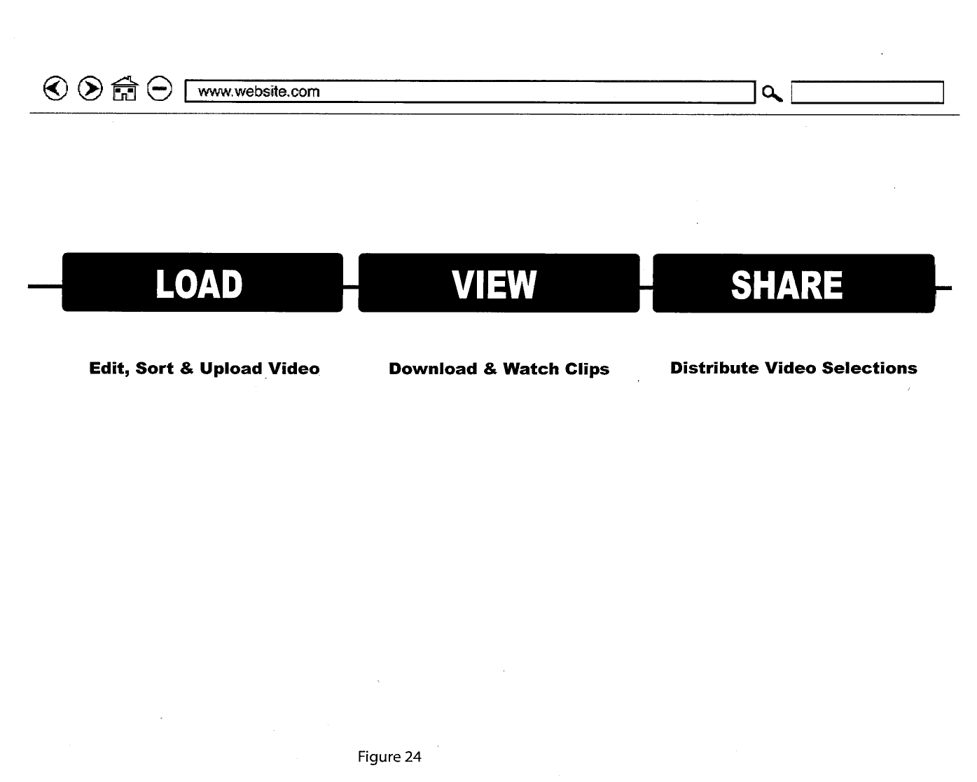

This section describes operations of the present invention as they relate to various screen shots provided in FIGS. 24-29. FIG. 24 depicts a first screen shot from a school application side. This screen shot depicts the home page where a user goes to launch the three different basic functionalities of the application. A user can click on load and from there go to a screen for management of the user's library. There are a number of different third party video editing applications that may be used to manage a user's library. In the library screen a user is allowed to load and manage game film. Additionally, in the management screen a user is allowed to associate the metadata of the players with the video, essentially managing all of the content of the video.

When managing metadata a user is allowed to describe the players who are on the field or the players who are on the roster of the particular team. The user has all has statistics about these players within their roster: their number, their height, their weight, their speed, etc. A coach can go in and select a player to showcase within the application when he's managing his rosters, where is it highlighted in an analysis document. The user/coach can then associate all that as metadata with the video. More specifically, the user can populate all the metadata within the application. Then once the user has finished managing the content of the player's metadata, the user can associate game metadata with the video and cross-reference the game metadata with the player metadata. Game metadata may include in a football scenario whether the play is a running play, passing play, first down, second down, right hash, personnel, etc.

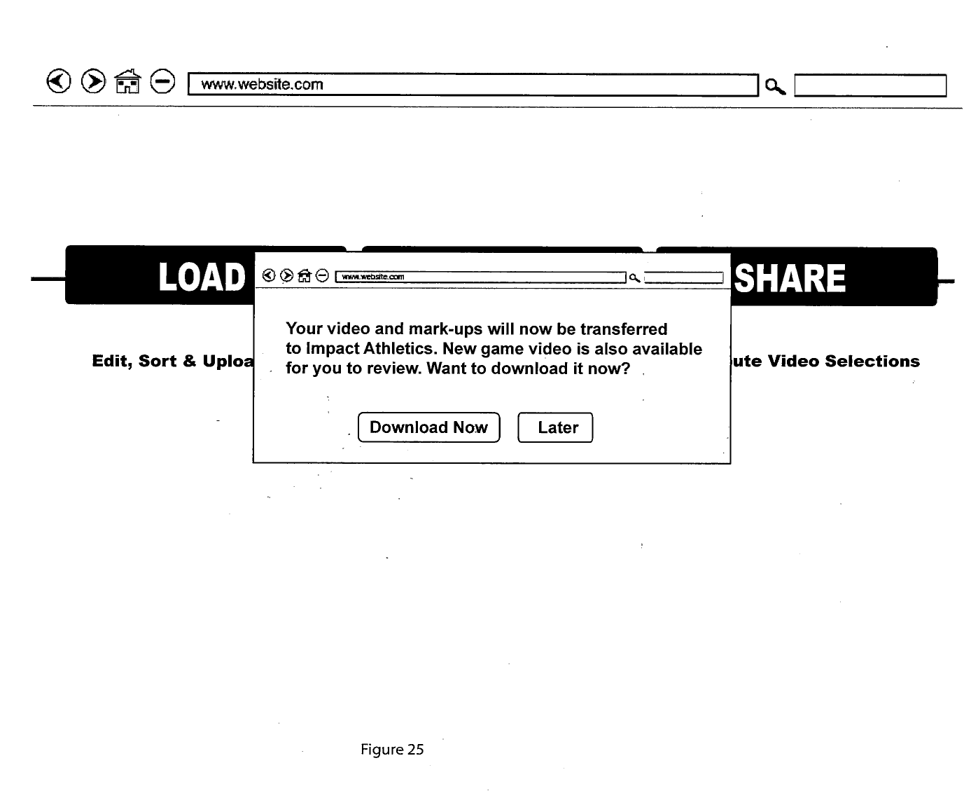

Player metadata, on the other hand, is all the bios and the stats associated with each player that is on the field at that time. Clicking Load on FIG. 24 sets in motion all of those actions that happened within that portion of the application. Once the user is done in the load screen the user uploads it to the central service. FIG. 25 depicts the screen shot that is displayed prior to uploading the video to the central service of host facility. If the user selects “Download Now,” then the entire content of the film itself, as well as all of the metadata that is associated with that content is transferred to the host in the upload step. In accordance with at least some embodiments of the present invention, the metadata is maintained in a spreadsheet format.

At the beginning when the coach goes through the sign-up process he can populate a spreadsheet and the central service uploads that to his profile or he can go through and click the drop downs to manually populate all of his players and roster. Within that, the coach also has the manage video functionality console: load, edit, sort, upload, etc. Additionally, the user can showcase specific players within the application or within their roster. If there are specific players, a coach can click on the player's line item and attach additional recruiting videos including a workout video, running the 40 yards, doing the bench press, doing the vertical leap, etc. That is all a part of the management functionality provided by the load screen accessed by the load button.

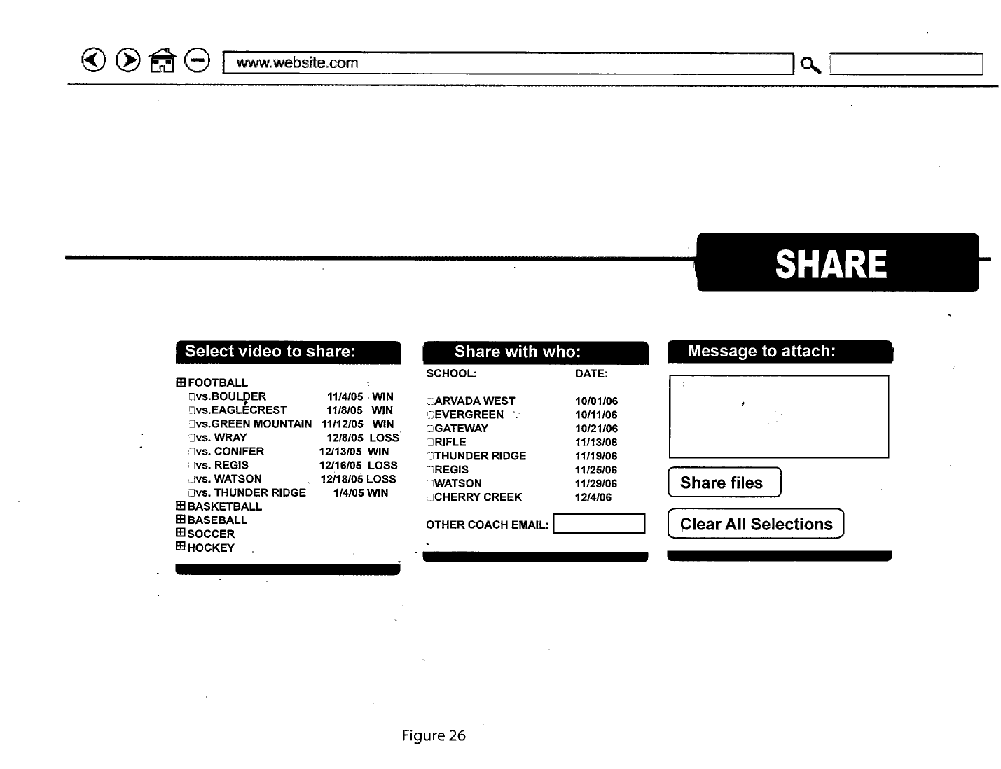

FIG. 26 depicts the screen that is displayed when a user clicks on the Share tab. Within the share screen, the share tab is displayed in the upper right hand corner. This is where the user can go to delegate and manage all of his/her contents. In the example depicts, the plus minus box next to Football has been clicked to expand the user menu. On the left side of the screen are current games that have been played and are in the library. These films already have metadata associated therewith as well as the result of the game. The user can also select which opposing coach should have access to the selected games. The coaches in the middle box are other coaches (e.g., within the same conference). The using coach can drill down in this middle box to find specific coaches based on certain criteria. The using coach can collaborate with such coaches or share film with coaches outside the conference or at a higher level (e.g., college, semi-pro, pro, etc.) for scouting purposes. Although not depicted, it should be noted that mutual delegation or coach selection could be used to determine which coaches have access to which films. In other words, a game film may be marked as requiring mutual delegation prior to allowing sharing with another coach either as metadata or within the central service host application. This means that one team's film is not released to the other coach until he's mutually delegated one or more films for sharing with the opposing coach. Mutual delegation may be performed on a one-to-one basis, where each coach allows the sharing of one film for each film that he is allowed access to. This eliminates the possibility that one coach can access three films while only sharing.

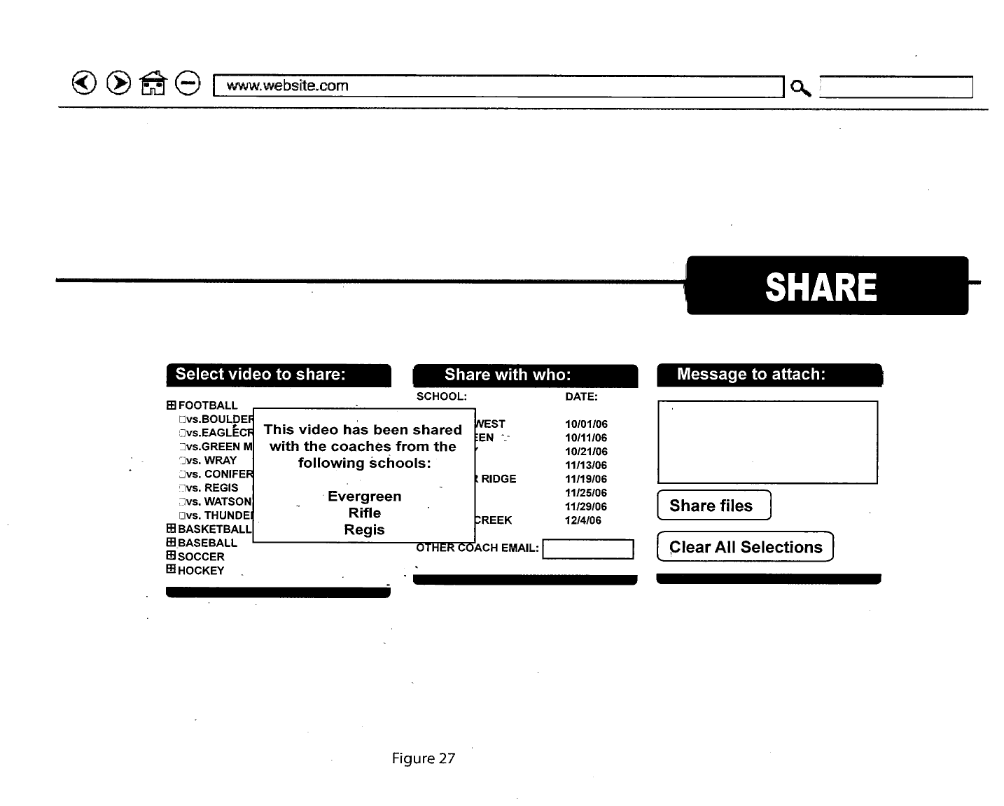

FIG. 27 depicts a screen shot where a coach user can mouse over on the left side of the screen and find out if a film has already been shared with another coach. This information may be maintained at the central service host application and displayed to the coach at the user application end.

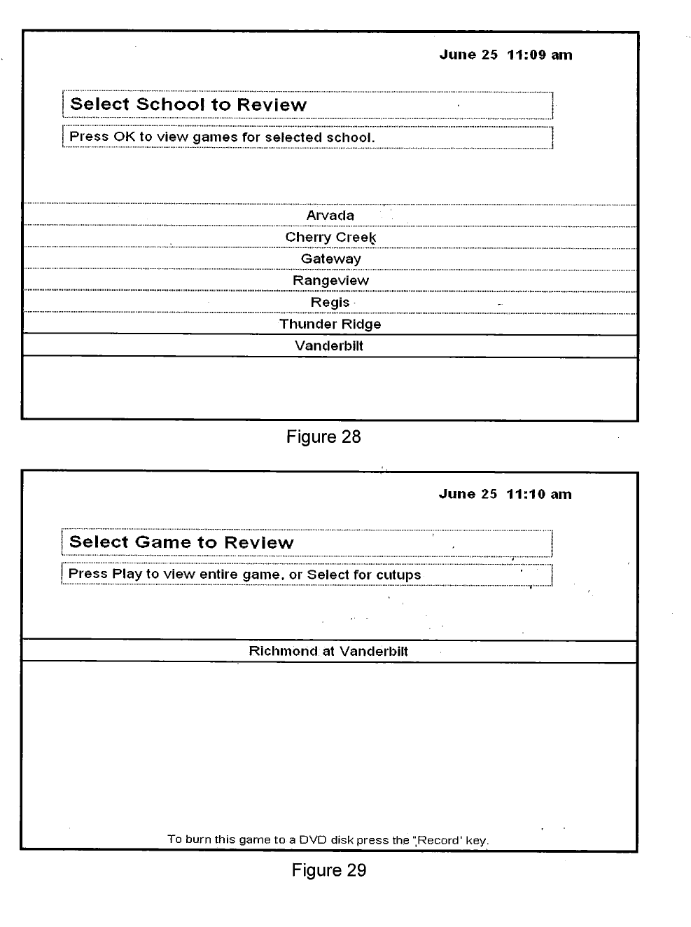

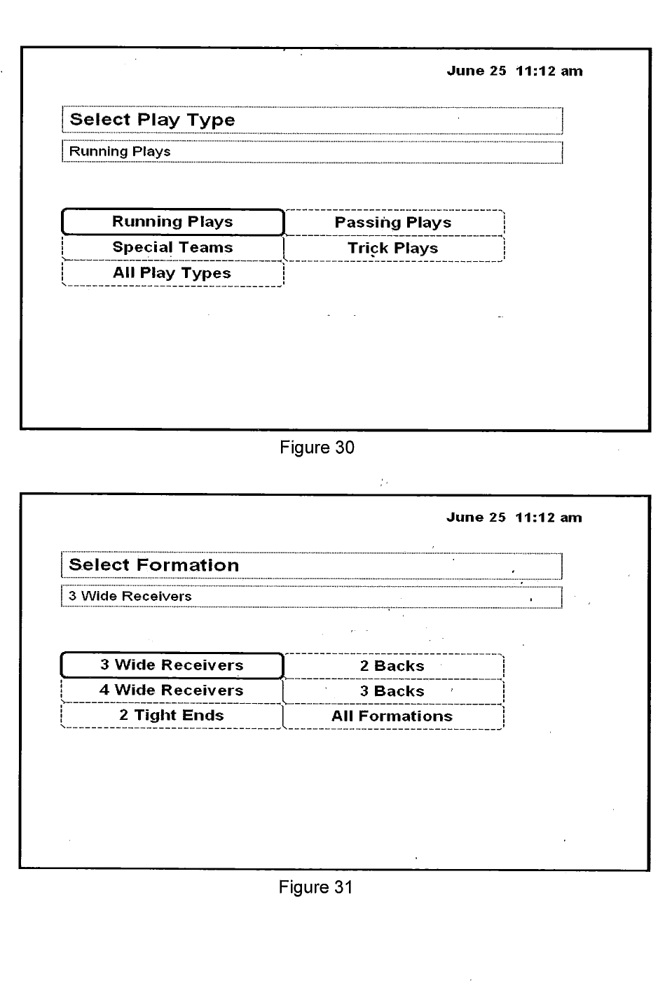

FIGS. 28 and 29 depict screen shots that are accessed by clicking on the View link from the launch page of FIG. 24. FIG. 28 is a high-school version and FIG. 29 is the college version. Upon clicking on the View link, the user is directed to a My Library space. This is the video on demand engine that can be used by remote control to scroll and query and find the content that a user wants to watch. If sorting by Game, the user is allowed to click on first game that he/she wants to watch. Upon selecting a game the screen transitions to the screen shot depicted in FIG. 30.

The screen depicted in FIG. 30 allows a user to drill down more on the game metadata. As a high school coach, a user may want to watch content based on specific qualifiers such as all plays, only running plays, only passing plays, only special teams, all of which may depend on who the coach user is watching the film with.

FIG. 31 depicts a drill down screen that is provided after selecting one of the options from FIG. 30. In FIG. 31 a user can drill down based on down and distance providing additional qualifiers for the type of in game video that a coach user wants to watch.

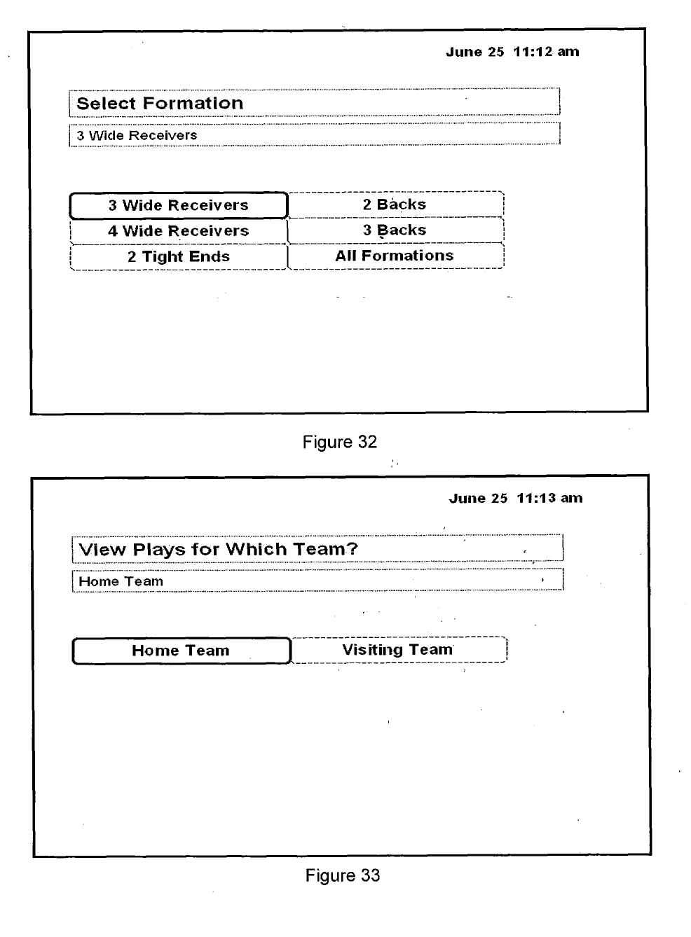

After selecting an option from FIG. 31, the display changes to that depicted in FIG. 32 where a coach user can drill down based on the player personnel (e.g., who's on the field, how many running backs, how many receivers, etc.) as well as specific formations or sets.

When an option is selected from the drill down menu provided in FIG. 32, the screen is transitioned to that shown in FIG. 33. FIG. 33 allows a coach user to select which plays and for which team should be viewed. As an example, an offensive coordinator for one team may which to view all defensive plays for an opposing team or conversely a defensive coordinator may wish to view all offensive plays for an opposing team. Alternatively, a team may review its own game film from a previous game in which case the offensive unit may watch the offensive plays and the defensive unit may watch the defensive plays.

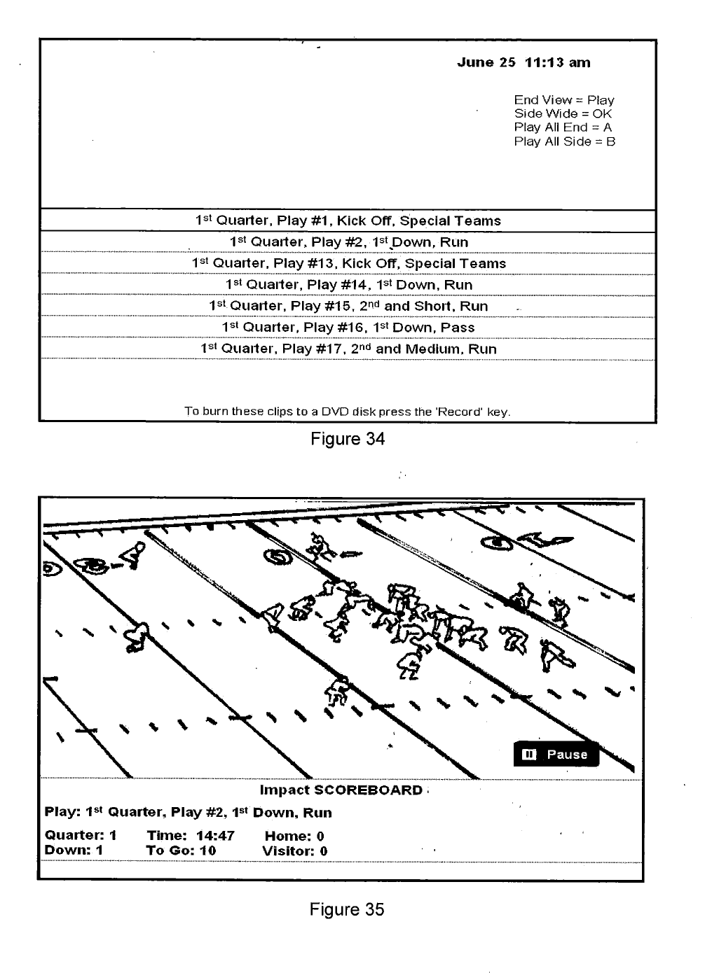

FIG. 34 depicts a screen shot that shows the results of the query that was just selected from the previous drill down options. At the bottom of the screen, the user is provided with the option “To burn these clips to DVD, press record key.” A user can then insert a DVD into a laptop or whatever he/she is watching the film on and output the entire results of the query as a “cut up project” to disc. Alternatively, the user can watch the results from the query sequentially or one at a time in normal view or side-wide view.

FIG. 35 depicts a screen shot that shows the replay of a specific play on side-wide view that also includes the scoreboard below. A user can select any kind of metadata associated with a section of film for display at the bottom of the screen (e.g., the results of the query, the current down and distance, time on the clock, etc.). The data that is on this screen here is ultimately obtained from the metadata that's uploaded originally as far as down and distance, play, formation, even players on the field. Game time information may also be associated with the video in the form of metadata.

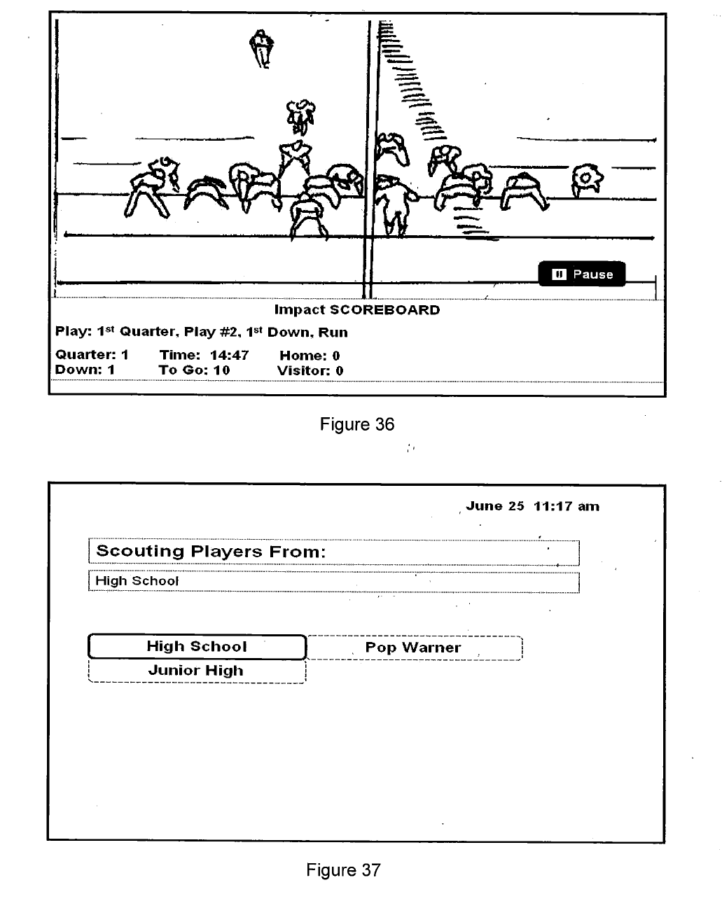

FIG. 36 depicts a screen shot that shows the replay of a specific play from an end view. This end view may be a wide-angle view or a tight view angle.

FIG. 37 depicts a screen shot for use in association with a recruiting application. The page may be used by university or other college coaches for recruiting high school athletes, but may also be useful for pro level coaches scouting college and high school athletes. A recruiter using the recruiting application could be anyone from an International team or a minor league team or minor league hockey, baseball, or any kind of club team that wants access to the database. The recruiting application assists coaches in recruiting players from high school, Pop Warner, junior high, international aspects, and so on. The features available to a user may also depend upon the player and league of interest.

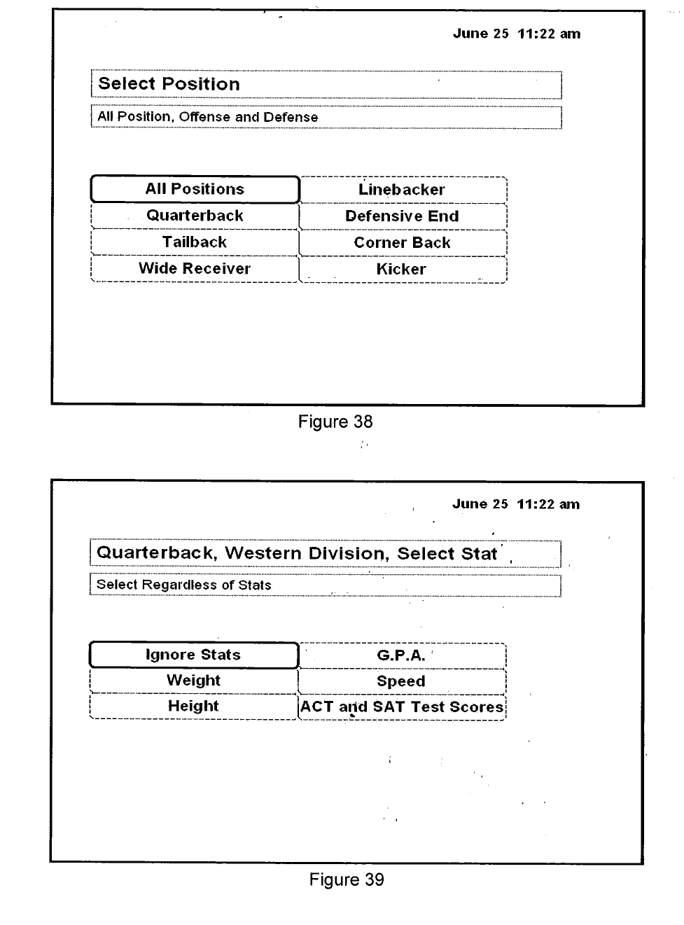

FIG. 38 depicts a screen shot that is presented after the recruiting user has selected a league to recruit from. In this screen the user is presented with a next set of query options where he/she can select various searching attributes. A recruiting user can create a query based on player metadata. More specifically, a recruiting user can search game films and player profiles based on certain search criteria. A player trying to get recruited or his/her coach can associate any kind of metadata with the player's profile. There may be five to ten required qualifiers that every player can associate with their game film data. Additional qualifiers may be selectively associated with game film and a profile in the form of metadata.

FIG. 39 depicts a screen shot showing some intangibles that may be employed as searching criteria such as statistical information. A recruiting user may access any type of intangible information associated with a player profile from this screen. The types of intangible information that may be associated with a player profile and subsequently searched by a recruiting user may include GPA, weight, speed, height, and test scores.

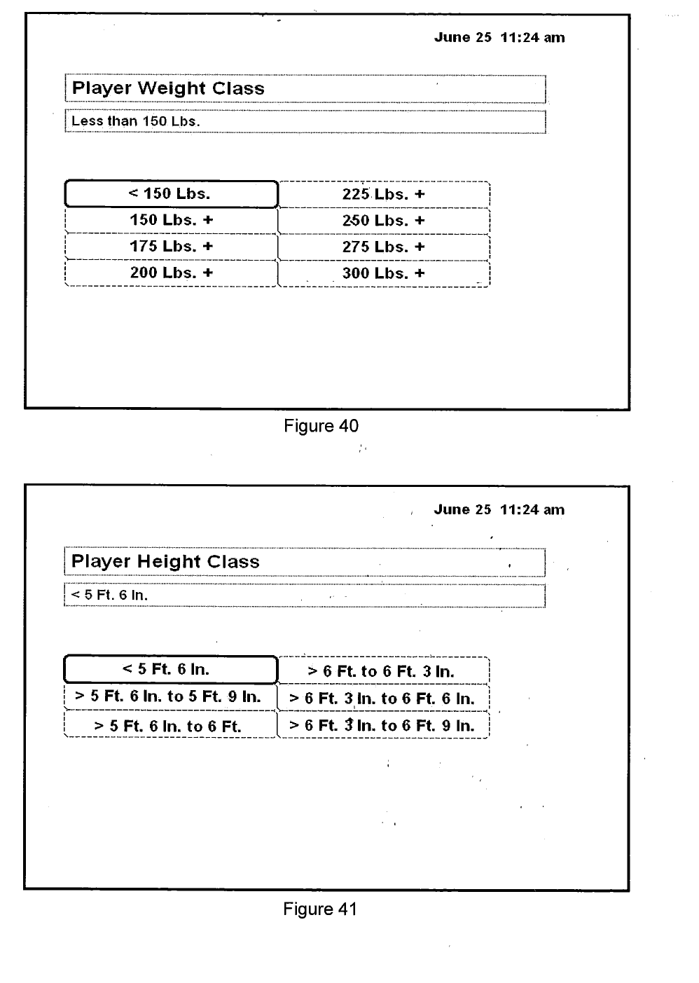

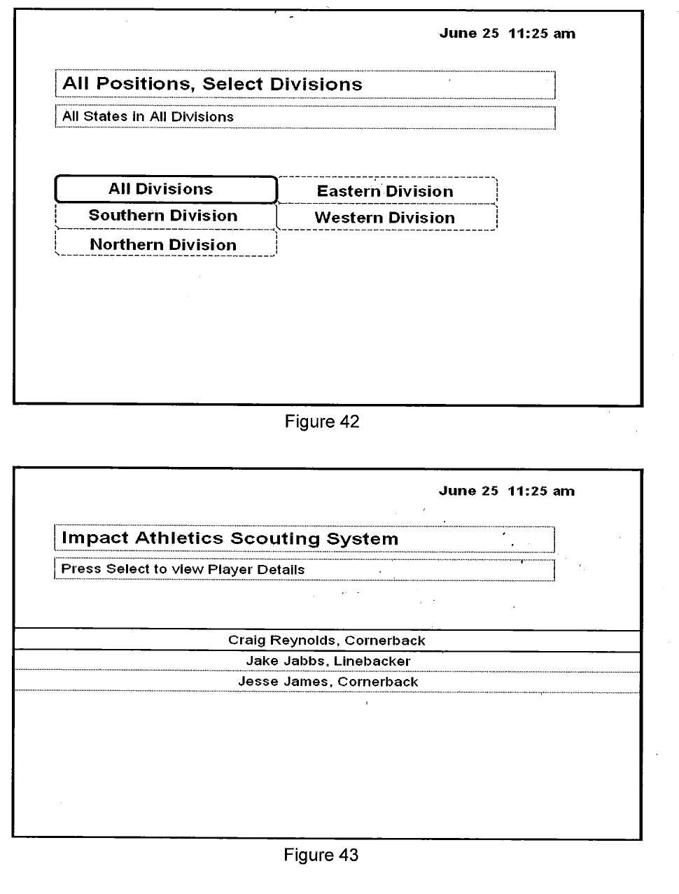

FIGS. 40 and 41 depict screen shots that can be accessed by selecting either the weight or height option from FIG. 39 respectively. By selecting certain height and weight qualifiers a recruiting user can try to search for players based on physical attributes. After the recruiting user selects one or more intangible attributes as search criteria, the recruiting user is presented with an option to sort players based on geography or school size as is depicted in FIG. 42. A recruiting user can focus on the Southern division of Florida or California specifically, then goes to a specific conference or county or school name or only 6A schools or only 5A schools within that state.

FIG. 43 depicts a screen shot showing results of the query created by a recruiting user as they stepped through FIGS. 37-42. After the recruiting user has performed the query steps, these are the players that meet the criteria are presented to the recruiting user. The recruiting user can then select a user from those that meet the criteria. In the depicted embodiment, the recruiting user selects a particular player named Craig Reynolds.

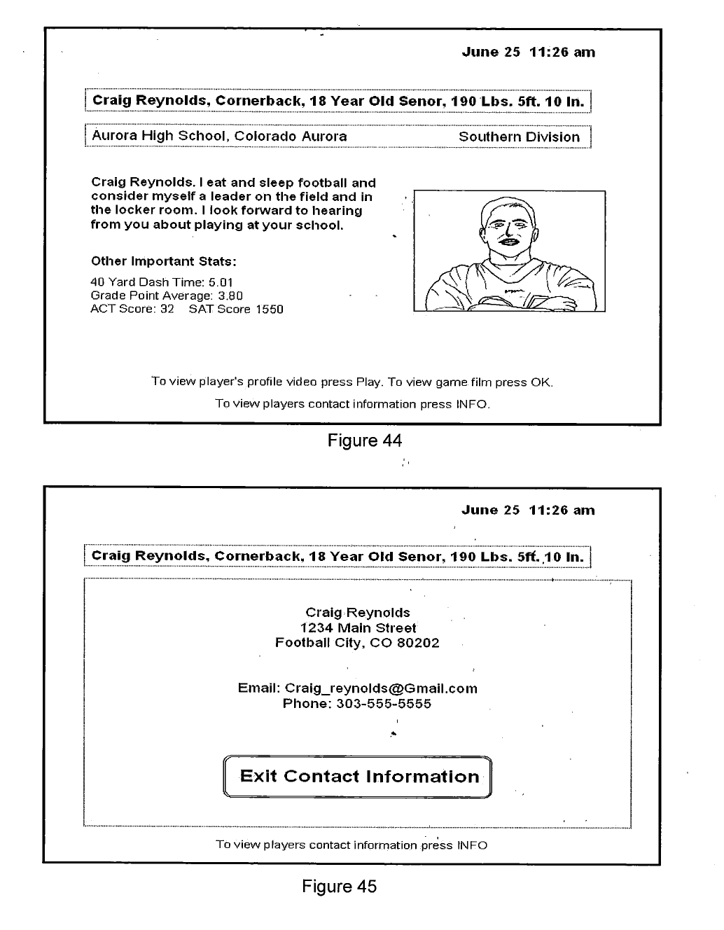

FIG. 44 depicts Craig's homepage. A coach may elect to showcase one or more of his/her players for recruiters. Craig is one of the players showcased by his coach. The homepage depicts all of the information associated with the Craig such as his statistics, biography, personal information, and so on. From here a recruiting user clicks the info link, and is directed to an information screen depicted in FIG. 45. The information screen can be integrated with a recruiting database such that the recruiting user is able to schedule a visit, a call, send a form letter, send an email, and so on to the selected user. Also included in the information screen is the contact information for the player's coach. This allows the recruiting user to contact the player's coach if he/she has any questions.

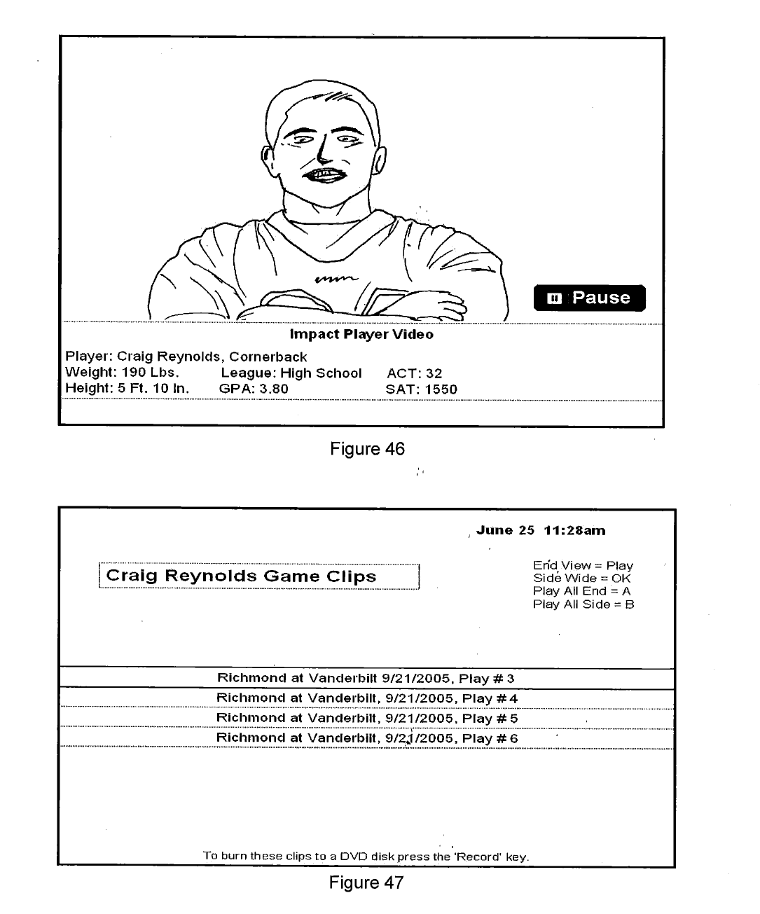

If the recruiting user selects the view player's video link, then the recruiting user is directed to a profile video screen as is depicted in FIG. 46. The recruiting user is then allowed to click play and watch Craig's video. The video may show an interview, any kind of a workout video, or the like that allows the recruiting user to see the player in action. Alternatively, the recruiting user can click OK and see his results or all of the video that is in the system having Craig therein as shown in FIG. 47. A selected player may be highlighted within the video. This is a user configurable feature that can be selectively activated based on the recruiting user's preference.

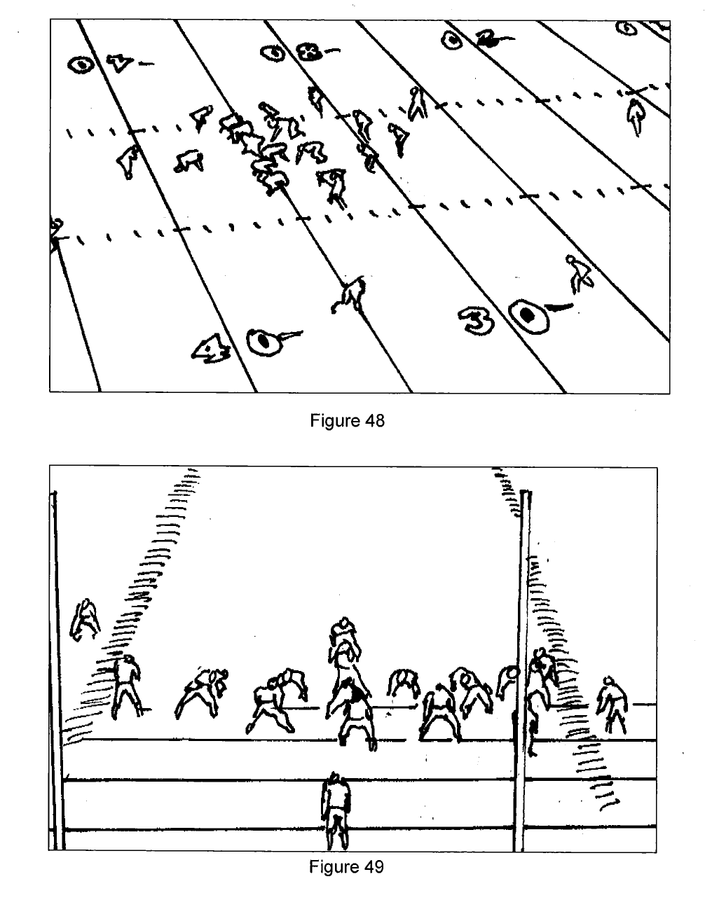

FIGS. 48 and 49 depict screen shots of game film presented based on the results of the query. FIG. 48 shows a side-wide view of game film that has the selected player in the camera view. FIG. 49 is the in-tight view of the same play. Each screen may be presented separately or concurrently based on user preference. Replay of the video may be altered in a number of different ways including: pause, rewind, fast-forward, rewind at ¼ speed, rewind at ½ speed, slow motion, or double speed.

Additional screens may be provided that allow a recruiting agent to automatically contact a player or the player's coach. For example, a menu driven screen may be provided that presents the recruiting user with an automatic link that establishes a communication session with the coach or player either by email, text message, a phone call, or the like.

After the data for a player has been evaluated, the recruiting user can make a decision to recruit or not recruit. At the beginning of the season when a recruiting user is filling out their profile and going through the sign-up process, they are going to fill out the needs of their program for that particular recruiting class. For example, a college recruiting user may have 20 scholarships to give out. Two of those scholarships may be needed for offensive linemen, four of them are for defensive linemen, two for linebackers, no quarterback this year, no kicker this year, etc. The application sets the size of the data that is in the database at that time for the subsequent recruiting class and make recommendations based on the recruiter's need. A third party information gathering service may also be employed which can be populated into the database and find the specific video for each one of those recommended players and put those in to a coach's profile as well. All of this video is maintained in the central service host facility and based on what a coach's specific needs are, the central service host facility can push content from the server to the TV set top box to match the recruiting user's needs. Once a coach user launches the application on his TV, all of the content is available to the coach user. He can bookmark the players that he likes and ignore others. The content is deleted or removed from the user's set top box and additional recommended video is broadcast to the set top box.

What is claimed is:

1. A system to provide services for sharing, analysis, and review of videos, and especially adapted for sport videos and data concerning athletes and teams, said system comprising:
at least one computer server having a data base for storing electronic data thereon;
a website accessible by a user over a communications network, said website having content thereon as provided through said server;
at least one user computer communicating with said website, said website having a plurality of user interfaces available to said user;
a plurality of video files created by the user or other users and uploaded to the server through the website;
means for providing sharing of the video files by other users located at different locations and who use their own computers for accessing and interacting with the website; and
a plurality of user interfaces provided to said users to select and review the content of the video files.

2. A system to provide services for sharing, analysis, and review of videos, and especially adapted for sport videos and data concerning athletes and teams, said system comprising:
providing at least one computer server having a data base for storing electronic data thereon;
providing a website accessible by a user over a communications network, said website having content thereon as provided through said server;
providing at least one user computer communicating with said website, said website having a plurality of user interfaces available to said user;
providing a plurality of video files created by the user or other users and uploaded to the server through the website;
electronic sharing of the video files between the user and the other users located at different locations and who use their own computers for accessing and interacting with the website; and
generating a plurality of user interface provided to said users to select and review the content of the video files.

3. A method, as claimed in claim 2, further including:
selecting a game schedule for a particular sport and season;
defining players and update player statistics on said video files;
uploading the updated player and game schedule information with metadata associated with said information.

4. A method, as claimed in claim 2, further including:
selectively sharing game videos between at least two users, a first user determining which films are to be shared, the second user agreeing to sharing the requested videos, and an administrator function releasing the requested videos once both users agree to the films to be released.

5. A system, as claimed in claim 2, wherein:
said sharing is achieved by e-mail communications between the two users, and said computer server tracks and releases the videos requested when both said users agree to the content to be shared.

6. A method, as claimed in claim 2, wherein:
a recruiter subscriber selects to search and query game video cut-ups;
said recruiter subscriber receiving the requested video cut-ups for selected data, and said recruiter subscriber receiving said data electronically for review of said information via visual display, including at least one of a computer monitor or television.
